(19) United States
(12) Patent Application Publication
(10) Pub. No.: US 2023/0127155 A1
(43) Pub. Date: Apr. 27, 2023

(54) STATOR HAVING COIL STRUCTURE OF DISTRIBUTED WINDING, AND THREE-PHASE AC ELECTRIC MOTOR COMPRISING SAID STATOR

(71) Applicant: FANUC CORPORATION, Yamanashi (JP)

(72) Inventor: Takashi ITO, Yamanashi (JP)

(21) Appl. No.: 17/905,641

(22) PCT Filed: Apr. 21, 2021
(86) PCT No.: PCT/JP2021/016210

§ 371 Date: Sep. 5, 2022

(30) Foreign Application Priority Data
Apr. 28, 2020 (JP) 2020-079782

(51) Int. Cl. H02K 3/28; H02K 3/12; H02K 1/16

(52) U.S. Cl. CPC H02K 3/28; H02K 3/12; H02K 1/16

(57) ABSTRACT

A three-phase AC electric motor in which the value obtained by dividing the number of slots by the number of poles is an irreducible fraction, wherein there is implemented a stator having a lap-winding coil structure of a distributed winding that can be wound automatically. A stator of a fractional-slot-type three-phase AC electric motor in which the number of slots of slots positioned in the circumferential direction is more than 1.5 times the number of poles, and in which the value obtained by dividing the number of slots by the number of poles is an irreducible fraction, the stator being such that each of two or three coils having the same coil pitch comprises a plurality of sets of coils that are offset for each slot pitch and that are positioned inside the slots, and each of the plurality of sets of coils is positioned at a location mutually offset by 60 degrees in the circumferential direction.

### TECHNICAL FIELD

The present invention relates to a stator having a coil structure of distributed winding, and a three-phase AC motor including the same.

### BACKGROUND ART

Conventionally, a three-phase AC motor including a fractional slot in which the value obtained by dividing the number of slots by the number of poles takes an irreducible fraction, as a combination of poles and slots that can reduce the cogging torque and the torque ripple of the three-phase AC motor, is known. Such a three-phase AC motor is also called a “fractional-slot three-phase AC motor.”

In the three-phase AC motor including a fractional slot, since the number of poles and the number of slots can be selected to set the least common multiple of the number of poles and the number of slots large, and the value of a high-order distributed winding factor can be set small, the torque ripple can be reduced.

In a three-phase AC motor including a fractional slot in which the number of slots is larger than 1.5 times the number of poles, the torque ripple is more likely to be small, but the coil pitch of windings inserted into the slots is higher than one slot (the distance between adjacent slots), and a coil structure of distributed winding is therefore involved.

Methods of distributed winding are roughly classified into three types: lap winding, concentric winding, and wave winding. Of these types of winding, lap winding refers to lapping coils having the same pitch. In lap winding, since less interference occurs between the coils, coil ends (the ends of the coil that are not accommodated in the stator) are small. In lap winding, further, an unconstrained winding arrangement can be advantageously achieved in three-phase AC motors in which the number of poles and the number of slots take most values.

In the three-phase AC motor including a fractional slot, the number of poles defined by an even number and the number of slots defined by a multiple of three can be selected from arbitrary values. Therefore, the number of slots can even be selected to take a small value relative to the selected number of poles. Since the coil pitch of each coil of the motor is approximately equal to the value obtained by dividing the number of slots by the number of poles, selecting the number of poles and the number of slots to set the coil pitch low (e.g., Coil Pitch=2 or 3) makes it possible to shorten the overall length of the motor, and to reduce the copper loss of the coils.

In the three-phase AC motor including a fractional slot, however, lap winding of a double-layer winding structure having a mixture of windings of two phases is generally formed per slot in specific slots. The specific slots have a double-layer winding structure, which involves a relatively large number of coils, resulting in a complicated winding structure of distributed winding.

In lap winding of the three-phase AC motor including a fractional slot, since a structure of two or more layers having a mixture of two phases in each specific slot is formed, an insulating part for electrically insulating the two phases from each other is involved in this slot. This further complicates the winding structure of distributed winding of the motor, and leads to a large number of parts used in the motor.

In lap winding of the three-phase AC motor including a fractional slot, further, two arbitrary adjacent coil ends align themselves parallel to each other at the coil ends of the coils. Therefore, two or more coils overlap each other in an arbitrary radial direction from the center of the stator toward the outer circumference of the stator, thus forming full circle winding. Therefore, an operation for interchanging some coils is involved in inserting the coils into the stator. In other words, it is difficult to automatically insert the coils into the stator, using, e.g., an inserter automatic winding machine in the manufacture of the motor.

A motor in which the number of coils per phase of the primary winding of an induction motor is set to ½×(Number of Poles), for example, is known (see, e.g., PTL 1).

In, e.g., a fractional-slot-winding three-phase armature winding of double-layer lap winding in which the number of slots q per pole per phase is represented as q=A+B/C (where A is an integer of 1 or more, B is a positive integer, C=4, 5, 7, and 8, and B/C is an irreducible fraction), a three-phase armature winding is known in which all phase belts are divided into groups of windings each having C continuous phase belts, one of the coils belonging to each group of windings is split into two coils each having conductors, the number of which is about a half the number of conductors of each remaining coil, the two coils are distributed to two adjacent phase belts, and the split coils are distributed in a parallel circuit (see, e.g., PTL 2).

In, e.g., an armature winding for a motor including a split stator, and formed by mounting three-phase AC armature coils of single-layer lap winding on a stator core so as not to span split portions of the stator, bending ends of adjacent armature coils of the armature coils in opposite directions, and connecting the ends to each other via an interpolar connection line, an armature winding for a motor is known in which a change connection line for changing an order of connection to obtain a predetermined voltage vector is provided in a connection portion between the armature coils having a predetermined phase (see, e.g., PTL 3).

In, e.g., a stator for a rotating electrical machine including an annular stator core having a plurality of slots arranged along an inner circumference to open on the inner circumference, and a distributed winding coil inserted into two slots paired and having an odd number pitch among the plurality of slots in the stator core, a stator for a rotating electrical machine is known in which the stator core is split in a circumferential direction at a position of a bottom of the slots into stator core forming portions each including two teeth, and at least one surface of opposite surfaces segmenting the slot at a split position of the stator core has a projection formed at a position more to a center of the stator core than a position of an end of the coil on an inner circumferential side so that a circumferential width of the slot in a portion having the projection formed is smaller than a width of the coil (see, e.g., PTL 4).

In, e.g., a three-phase AC motor in which letting P be the number of pole pairs on a rotor of a motor, and N be the number of slots to insert windings of a stator, N/(6P) is set to an irreducible fraction having a denominator value of 4 or more, and N>3P holds, a three-phase AC motor is known in which one winding of windings of a total of six phase belts: three phases and phases opposite to the three phases is divided into two layers per slot and disposed in each slot to insert the winding, so that in a winding arrangement of one layer in windings of the two layers disposed in each slot, windings of three phases: a U phase, a V phase, and a W phase are disposed to have rotational symmetry through ±120 mechanical degrees, and in a winding arrangement of the other layer, windings are inverted in phase by 180 electrical degrees from respective phases of the windings of the first layer having the rotational symmetry, and disposed to be shifted from the windings of the first layer by M slots, and the number of pole pairs P, the number of slots N, and the number of slot shifts M satisfy the following relation: 4/35≤|T−2PM/N|≤8/35, where T is an arbitrary odd number (see, e.g., PTL 5).

In, e.g., a stator for a three-phase AC motor including a rotor having a plurality of pairs of magnetic poles, a stator including a plurality of slots formed to extend in a direction of an axis of rotation of the rotor and aligned in a circumferential direction, the stator facing the rotor in a radial direction, and a plurality of windings inserted into the slots and wound on the stator, the motor in which letting 2P be the number of poles on the rotor, and 6N be the number of slots to insert the windings of the stator, a value obtained by dividing the number of slots 6N by the number of pole pairs P takes an irreducible fraction, and 2N>P holds, a three-phase AC motor is known in which letting X be a quotient of the number of slots 6N divided by the number of poles 2P, coils wound with a predetermined number of turns are disposed in 2N slots per phase on the stator, each coil is disposed in one central slot to overlap another coil connected in series with the each coil, with one side of the each coil shared with the other coil to pass currents through the two coils in an identical direction, the other side, opposite to the one side, of each of the two coils on which the slot is not shared is disposed in another slot spaced apart from the central slot by X so that the two coils are connected to each other in a figure of 8 across three slots, and N sets of coils of the two coils connected to each other in the figure of 8 are disposed in the slots of the stator at positions that do not completely overlap each other per phase, and connected in series with each other (see, e.g., PTL 6).

### CITATIONS LIST

### Patent Literature

[PTL 1] Japanese Unexamined Patent Publication (Kokai) No. S49-114713
[PTL 2] Japanese Unexamined Patent Publication (Kokai) No. S59-222066
[PTL 3] Japanese Unexamined Patent Publication (Kokai) No. S63-31439

### [PTL 4] Japanese Unexamined Patent Publication (Kokai) No. 2011-199967

### [PTL 5] Japanese Unexamined Patent Publication (Kokai) No. 2016-5409

### [PTL 6] Japanese Unexamined Patent Publication (Kokai) No. 2017-11959

### SUMMARY OF INVENTION

### Technical Problem

In a three-phase AC motor in which the value obtained by dividing the number of slots by the number of poles takes an irreducible fraction, since the arrangement of windings by distributed winding is complicated, and lap winding of distributed winding involves an operation for interchanging coils in coil insertion into a stator, the motor is unsuitable for automation of a winding process in its manufacture. It is, therefore, desired to achieve a lap winding coil structure of distributed winding that allows automatic winding in a three-phase AC motor in which the value obtained by dividing the number of slots by the number of poles takes an irreducible fraction.

### Solution to Problem

According to one aspect of the present disclosure, a stator for a fractional-slot three-phase alternating-current motor in which the number of slots of slots arranged in a circumferential direction is larger than 1.5 times the number of poles, and a value obtained by dividing the number of slots by the number of poles takes an irreducible fraction comprises a plurality of sets of coils each formed by one of a set of two coils and a set of three coils having an equal coil pitch and arranged in the slots to be shifted from each other by a slot pitch of 1, wherein the plurality of sets of coils are shifted in position from each other by 60 degrees in a circumferential direction.

According to another aspect of the present disclosure, a three-phase alternating-current motor comprises the above-mentioned stator, and a rotor facing the stator in a radial direction.

### Advantageous Effects of Invention

According to one aspect of the present disclosure, it is possible to achieve a stator having a lap winding coil structure of distributed winding that allows automatic winding in a three-phase AC motor in which the value obtained by dividing the number of slots by the number of poles takes an irreducible fraction.

### BRIEF DESCRIPTION OF DRAWINGS

FIG. 1 is a sectional view illustrating a stator in a 10-pole, 36-slot three-phase AC motor according to an embodiment of the present disclosure.

FIG. 2 is a developed sectional view of the stator illustrated in FIG. 1.

FIG. 3 is a developed sectional view for explaining each coil arrangement in the stator illustrated in FIG. 2.

FIG. 4 is a sectional view (part 1) for explaining the symmetry of the winding arrangement of the stator in the 10-pole, 36-slot three-phase AC motor illustrated in FIG. 1.

FIG. 5 is a sectional view for explaining the symmetry of U-phase windings of the stator illustrated in FIG. 4.

FIG. 6 is a sectional view for explaining the symmetry of V-phase windings of the stator illustrated in FIG. 4.

FIG. 7 is a sectional view for explaining the symmetry of W-phase windings of the stator illustrated in FIG. 4.

FIG. 8A is a sectional view (part 2) for explaining the symmetry of the winding arrangement of the stator in the 10-pole, 36-slot three-phase AC motor illustrated in FIG. 1, and depicts a −U-phase belt winding arrangement.

FIG. 8B is a sectional view (part 2) for explaining the symmetry of the winding arrangement of the stator in the 10-pole, 36-slot three-phase AC motor illustrated in FIG. 1, and depicts a +V-phase belt winding arrangement.

FIG. 8C is a sectional view (part 2) for explaining the symmetry of the winding arrangement of the stator in the 10-pole, 36-slot three-phase AC motor illustrated in FIG. 1, and depicts a −W-phase belt winding arrangement.

FIG. 8D is a sectional view (part 2) for explaining the symmetry of the winding arrangement of the stator in the 10-pole, 36-slot three-phase AC motor illustrated in FIG. 1, and depicts a +U-phase belt winding arrangement.

FIG. 8E is a sectional view (part 2) for explaining the symmetry of the winding arrangement of the stator in the 10-pole, 36-slot three-phase AC motor illustrated in FIG. 1, and depicts a −V-phase belt winding arrangement.

FIG. 8F is a sectional view (part 2) for explaining the symmetry of the winding arrangement of the stator in the 10-pole, 36-slot three-phase AC motor illustrated in FIG. 1, and depicts a +W-phase belt winding arrangement.

FIG. 9 is a sectional view illustrating the −U-phase belt winding arrangement depicted in FIG. 8A.

FIG. 10 is a sectional view illustrating a stator in a 10-pole, 24-slot three-phase AC motor according to an embodiment of the present disclosure.

FIG. 11 is a developed sectional view of the stator illustrated in FIG. 10.

FIG. 12 is a developed sectional view for explaining each coil arrangement in the stator illustrated in FIG. 11.

FIG. 13 is a sectional view illustrating a stator in a 14-pole, 24-slot three-phase AC motor according to an embodiment of the present disclosure.

FIG. 14 is a developed sectional view of the stator illustrated in FIG. 13.

FIG. 15 is a developed sectional view for explaining each coil arrangement in the stator illustrated in FIG. 13.

FIG. 16 is a sectional view illustrating a stator in a 22-pole, 48-slot three-phase AC motor according to an embodiment of the present disclosure.

FIG. 17 is a developed sectional view of the stator illustrated in FIG. 16.

FIG. 18 is a sectional view illustrating a stator in a 22-pole, 72-slot three-phase AC motor according to an embodiment of the present disclosure.

FIG. 19 is a developed sectional view of the stator illustrated in FIG. 18.

FIG. 20 is a sectional view illustrating a stator in a 34-pole, 108-slot three-phase AC motor according to an embodiment of the present disclosure.

FIG. 21 is a developed sectional view of the stator illustrated in FIG. 20 for slot identification numbers 1 to 54.

FIG. 22 is a developed sectional view of the stator illustrated in FIG. 20 for slot identification numbers 55 to 108.

FIG. 23 is a diagram illustrating an exemplary appearance of a three-phase AC motor including the stator according to any embodiment of the present disclosure.

FIG. 24A is a diagram illustrating an exemplary coil and an exemplary three-phase AC motor including the coil, and depicts an exemplary coil in the stator illustrated in each of FIGS. 3, 12, 15, 17, 19, 21, 22, and 25.

FIG. 24B is a diagram illustrating an exemplary coil and an exemplary three-phase AC motor including the coil, and depicts an exemplary positional relationship between a stator and a rotor of the three-phase AC motor.

FIG. 25 is a developed sectional view for explaining the definition of groups of coils in a stator according to an embodiment of the present disclosure.

### DESCRIPTION OF EMBODIMENTS

A stator having a lap winding coil structure of distributed winding, and a three-phase AC motor including the stator will be described below with reference to the drawings. In the drawings, the same or similar reference numerals denote the same or similar members. To facilitate understanding, these drawings use different scales as appropriate. Further, the modes illustrated in the drawings are merely examples for carrying out the present invention, which is not limited to the modes illustrated in the drawings.

In the following description, wire such as copper wire that passes a current through it, or a bundle of wires will be referred to as a “winding” hereinafter. A structure formed by wires shaped into a closed ring and stacked in a bundle as connected to each other in the same shape will be referred to as a “coil” hereinafter. Although the coil is divided into a portion accommodated in a slot of a stator and a portion that is not accommodated in the slot, the former will be referred to as a “winding” and the latter will be referred to as a “coil end” hereinafter, to clearly distinguish them from each other. The number of slots spanned by the coil accommodated in the slots of the stator will be referred to as a “coil pitch” hereinafter.

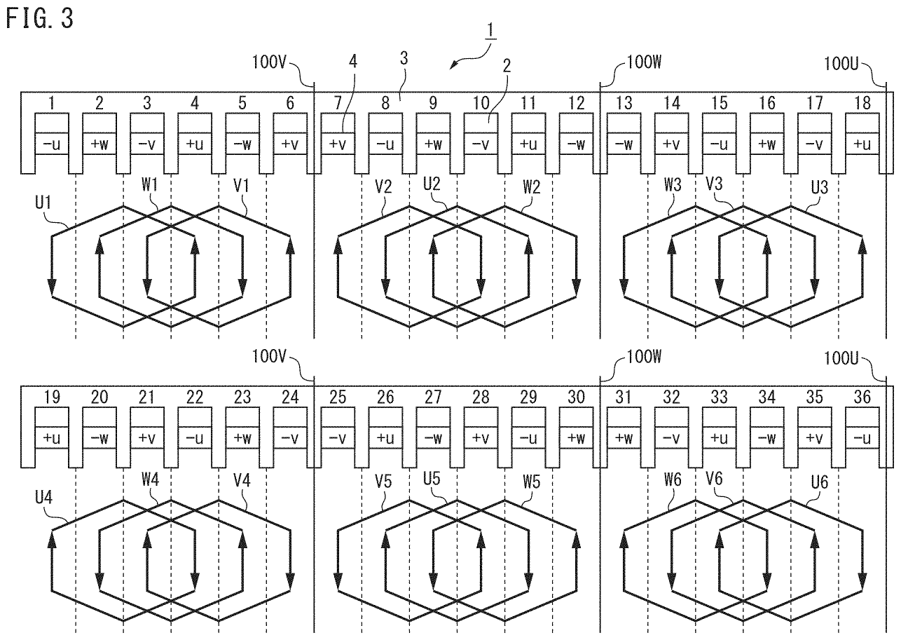

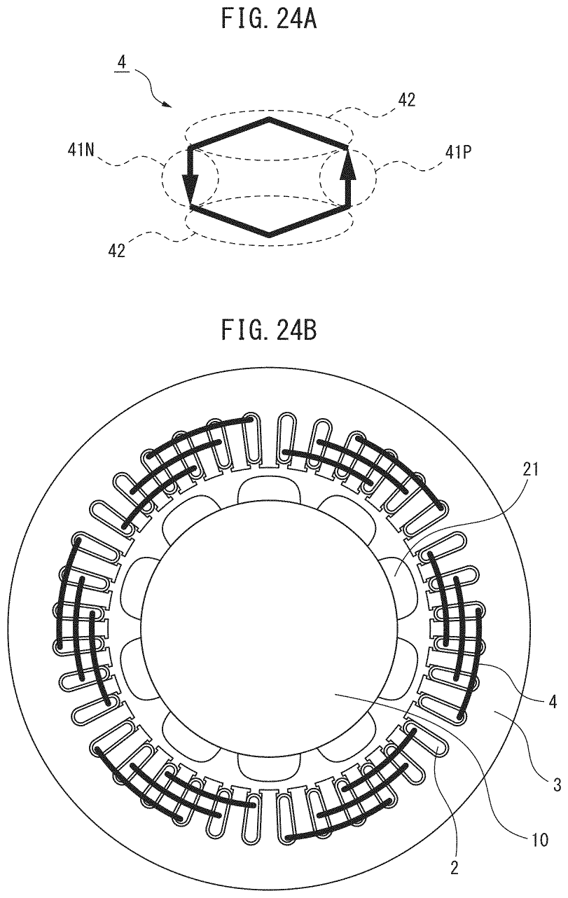

FIG. 24A is a diagram illustrating an exemplary coil and an exemplary three-phase AC motor including the coil, and depicts an exemplary coil in the stator illustrated in each of FIGS. 3, 12, 15, 17, 19, 21, 22, and 25. FIG. 24B is a diagram illustrating an exemplary coil and an exemplary three-phase AC motor including the coil, and depicts an exemplary positional relationship between a stator and a rotor of the three-phase AC motor. A coil 4 is formed by a positive winding (+winding) 41P and a negative winding (−winding) 41N accommodated in slots, and coil ends 42 that are not accommodated in the slots, as illustrated in FIG. 24A. A rotor 10 radially faces a stator 1 having coils (windings) 4 accommodated in slots 2, as illustrated in FIG. 24B. Magnetic poles 21 of magnets are set on the rotor 10.

Since 180-degree out-of-phase currents respectively flow through the two windings (the positive winding and the negative winding) of the coil accommodated in the slots, a coil pitch corresponding to about 180 electrical degrees or a mechanical angle of about “(180 Degrees)/(Number of Poles)” is involved per pole. In an embodiment of the present disclosure, the coil pitch is defined by “Decimal Integer Part, That Is, Quotient of Value Obtained by (Number of Slots)/(Number of Poles)” or “(Decimal Integer Part, That Is, Quotient of Value Obtained by (Number of Slots)/(Number of Poles))+1.”

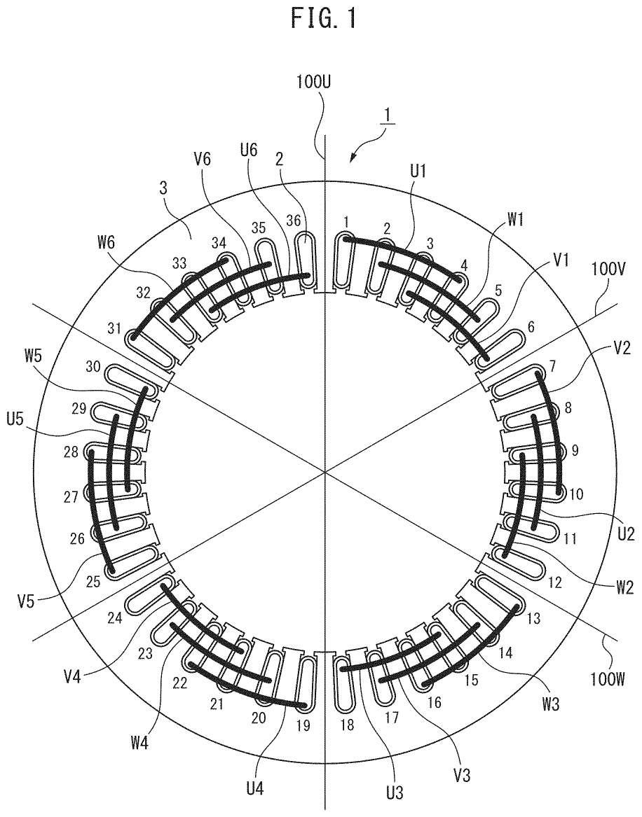

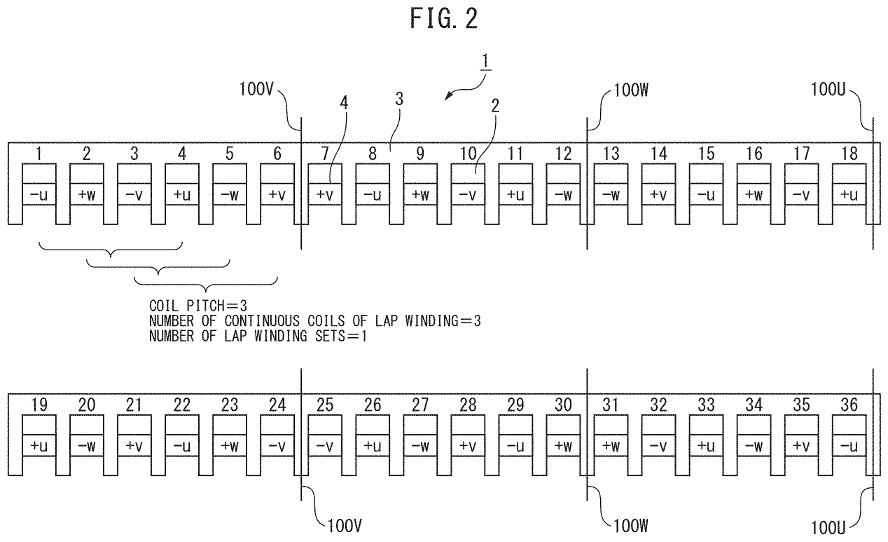

FIG. 1 is a sectional view illustrating a stator in a 10-pole, 36-slot three-phase AC motor according to an embodiment of the present disclosure. FIG. 2 is a developed sectional view of the stator illustrated in FIG. 1. FIG. 3 is a developed sectional view for explaining each coil arrangement in the stator illustrated in FIG. 2. Magnetic poles on a rotor are not illustrated in FIGS. 1 to 3. In FIGS. 1 to 3 and the subsequent drawings, U, V, and W represent the respective phases of a three-phase alternating current and are out of phase with each other by ±120 electrical degrees. “+” and “−” represent the directions of currents and are out of phase with each other by 180 electrical degrees. Two of a total of six phase belts: the +U, −U, +V, −V, +W, and −W phases are disposed in each slot 2 formed in a core 3 of the stator 1. The same number of wires such as copper wires that pass currents through them are inserted in each arrangement. The stator 1 has a cylindrical shape in practice, but a developed sectional view depicting the cylindrical stator 1 as developed linearly will also be referred to herein in the following description, to facilitate understanding.

A three-phase AC motor according to an embodiment of the present disclosure is provided as a fractional-slot three-phase AC motor in which the number of slots 2 arranged in the circumferential direction is larger than 1.5 times the number of poles, and the value obtained by dividing the number of slots by the number of poles takes an irreducible fraction, and the motor includes a stator 1, and a rotor facing the stator 1 in the radial direction. Letting P be the number of pole pairs on the rotor of the three-phase AC motor, the number of poles is equal to 2P. Letting 6N be the number of slots to insert windings of the stator 1, the value obtained by dividing the number of slots 6N by the number of poles 2P represents the slot pitch of a coil 4. In the three-phase AC motor in which the value obtained by dividing the number of slots 6N by the number of poles 2P is larger than 1.5, the slot pitch of the coil is 2 or more, thus involving a coil structure of distributed winding (lap winding). Referring to FIG. 1, a plurality of coils having the same coil pitch shape by lap winding are arranged in the slots by lap winding of three coils to be shifted from each other by one slot. The coils wound by lap winding to be shifted from each other by one slot in this manner will be referred to as the “number of continuous coils” hereinafter. Referring to FIG. 1, the number of continuous coils is 3 in all lap winding sets.

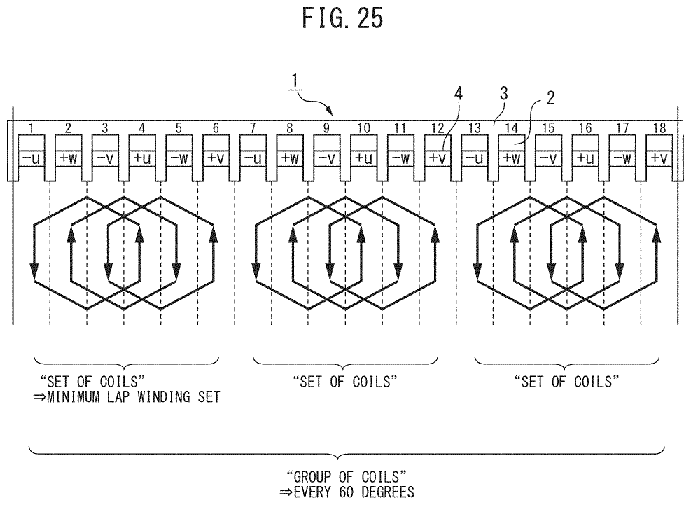

The stator 1 according to the embodiment of the present disclosure includes a plurality of sets of coils each formed by two or three coils 4 having the same coil pitch and arranged in the slots to be shifted from each other by a slot pitch of 1. The plurality of sets of coils are further divided into six groups of coils and disposed in all the slots and, more specifically, the groups of coils are shifted in position from each other by 60 degrees. FIG. 25 is a developed sectional view for explaining the definition of groups of coils in a stator according to an embodiment of the present disclosure. In this specification, the “set (of coils)” means a group formed by a plurality of (in the example illustrated in FIG. 25, three) coils having the same coil pitch shape by lap winding. The “groups of coils” mean groups, each of which is formed by a plurality of sets of coils and which are shifted in position from each other by 60 degrees.

The six groups of coils will be respectively referred to as a first group of coils, a second group of coils, a third group of coils, a fourth group of coils, a fifth group of coils, and a sixth group of coils hereinafter. In each of the first to sixth groups of coils, the coils are shaped to have the same coil pitch and arranged in the slots by lap winding to be shifted from each other by a slot pitch of 1.

In the 10-pole, 36-slot three-phase AC motor, the quotient of 3, that is, the decimal integer part of the value obtained by dividing the number of slots of 36 by the number of poles of 10 is determined as the coil pitch of the stator, as illustrated in FIG. 2. Since the number of slots of the stator 1 is 36, the respective coils of the U, V, and W phases are arranged as equally divided into six groups of coils throughout all the 36 slots, thus allowing lap winding in each group. The number of continuous coils of lap winding for 10 poles and 36 slots is 3, as illustrated in FIG. 2. Accordingly, three coils each having a coil pitch of 3 form one lap winding set across six slots in each set, and these sets are spaced apart from each other. These three coils respectively serve as a U-phase winding defined as a first-phase winding, a V-phase winding defined as a second-phase winding, and a W-phase winding defined as a third-phase winding. Specific details are as follows.

In the first group of coils, three coils U1, W1, and V1 having the same coil pitch are arranged in slots shifted from each other by a slot pitch of 1. More specifically, the coil U1 is disposed in the slots having slot identification numbers 1 and 4, upon being shaped so that currents flow in opposite directions through the winding disposed in the slot having slot identification number 1 and the winding disposed in the slot having slot identification number 4 shifted from the slot having slot identification number 1 by a coil pitch of 3. The coil W1 is disposed in slots shifted from those of the coil V1 by a slot pitch of 1. In other words, the coil W1 is disposed in the slots having slot identification numbers 2 and 5, upon being shaped so that currents flow in opposite directions through the winding disposed in the slot having slot identification number 2 and the winding disposed in the slot having slot identification number 5. The coil V1 is disposed in slots shifted from those of the coil W1 by a slot pitch of 1. In other words, the coil V1 is disposed in the slots having slot identification numbers 3 and 6, upon being shaped so that currents flow in opposite directions through the winding disposed in the slot having slot identification number 3 and the winding disposed in the slot having slot identification number 6.

In the second group of coils, three coils V2, U2, and W2 having the same coil pitch are arranged in slots shifted from each other by a slot pitch of 1. The second group of coils is shifted in position from the first group of coils by 60 degrees in the circumferential direction (in the example illustrated in FIG. 1, clockwise). More specifically, the coil V2 is disposed in the slots having slot identification numbers 7 and 10, upon being shaped so that currents flow in opposite directions through the winding disposed in the slot having slot identification number 7 and the winding disposed in the slot having slot identification number 10. The coil U2 is disposed in slots shifted from those of the coil V2 by a slot pitch of 1. In other words, the coil U2 is disposed in the slots having slot identification numbers 8 and 11, upon being shaped so that currents flow in opposite directions through the winding disposed in the slot having slot identification number 8 and the winding disposed in the slot having slot identification number 11. The coil W2 is disposed in slots shifted from those of the coil U2 by a slot pitch of 1. In other words, the coil W2 is disposed in the slots having slot identification numbers 9 and 12, upon being shaped so that currents flow in opposite directions through the winding disposed in the slot having slot identification number 9 and the winding disposed in the slot having slot identification number 12.

In the third group of coils, three coils W3, V3, and U3 having the same coil pitch are arranged in slots shifted from each other by a slot pitch of 1. The third group of coils is shifted in position from the second group of coils by 60 degrees in the same direction (i.e., clockwise) as the above-mentioned circumferential direction. More specifically, the coil W3 is disposed in the slots having slot identification numbers 13 and 16, upon being shaped so that currents flow in opposite directions through the winding disposed in the slot having slot identification number 13 and the winding disposed in the slot having slot identification number 16. The coil V3 is disposed in slots shifted from those of the coil W3 by a slot pitch of 1. In other words, the coil V3 is disposed in the slots having slot identification numbers 14 and 17, upon being shaped so that currents flow in opposite directions through the winding disposed in the slot having slot identification number 14 and the winding disposed in the slot having slot identification number 17. The coil U3 is disposed in slots shifted from those of the coil V3 by a slot pitch of 1. In other words, the coil U3 is disposed in the slots having slot identification numbers 15 and 18, upon being shaped so that currents flow in opposite directions through the winding disposed in the slot having slot identification number 15 and the winding disposed in the slot having slot identification number 18.

In the fourth group of coils, three coils U4, W4, and V4 having the same coil pitch are arranged in slots shifted from each other by a slot pitch of 1. The fourth group of coils is shifted in position from the third group of coils by 60 degrees in the same direction (i.e., clockwise) as the above-mentioned circumferential direction. More specifically, the coil U4 is disposed in the slots having slot identification numbers 19 and 22, upon being shaped so that currents flow in opposite directions through the winding disposed in the slot having slot identification number 19 and the winding disposed in the slot having slot identification number 22. The coil W4 is disposed in slots shifted from those of the coil U4 by a slot pitch of 1. In other words, the coil W4 is disposed in the slots having slot identification numbers 20 and 23, upon being shaped so that currents flow in opposite directions through the winding disposed in the slot having slot identification number 20 and the winding disposed in the slot having slot identification number 23. The coil V4 is disposed in slots shifted from those of the coil W4 by a slot pitch of 1. In other words, the coil V4 is disposed in the slots having slot identification numbers 21 and 24, upon being shaped so that currents flow in opposite directions through the winding disposed in the slot having slot identification number 21 and the winding disposed in the slot having slot identification number 24.

In the fifth group of coils, three coils V5, U5, and W5 having the same coil pitch are arranged in slots shifted from each other by a slot pitch of 1. The fifth group of coils is shifted in position from the fourth group of coils by 60 degrees in the same direction (i.e., clockwise) as the above-mentioned circumferential direction. More specifically, the coil V5 is disposed in the slots having slot identification numbers 25 and 28, upon being shaped so that currents flow in opposite directions through the winding disposed in the slot having slot identification number 25 and the winding disposed in the slot having slot identification number 28. The coil U5 is disposed in slots shifted from those of the coil V5 by a slot pitch of 1. In other words, the coil U5 is disposed in the slots having slot identification numbers 26 and 29, upon being shaped so that currents flow in opposite directions through the winding disposed in the slot having slot identification number 26 and the winding disposed in the slot having slot identification number 29. The coil W5 is disposed in slots shifted from those of the coil U5 by a slot pitch of 1. In other words, the coil W5 is disposed in the slots having slot identification numbers 27 and 30, upon being shaped so that currents flow in opposite directions through the winding disposed in the slot having slot identification number 27 and the winding disposed in the slot having slot identification number 30.

In the sixth group of coils, three coils W6, V6, and U6 having the same coil pitch are arranged in slots shifted from each other by a slot pitch of 1. The sixth group of coils is shifted in position from the fifth group of coils by 60 degrees in the same direction (i.e., clockwise) as the above-mentioned circumferential direction. More specifically, the coil W6 is disposed in the slots having slot identification numbers 31 and 34, upon being shaped so that currents flow in opposite directions through the winding disposed in the slot having slot identification number 31 and the winding disposed in the slot having slot identification number 34. The coil V6 is disposed in slots shifted from those of the coil W6 by a slot pitch of 1. In other words, the coil V6 is disposed in the slots having slot identification numbers 32 and 35, upon being shaped so that currents flow in opposite directions through the winding disposed in the slot having slot identification number 32 and the winding disposed in the slot having slot identification number 35. The coil U6 is disposed in slots shifted from those of the coil V6 by a slot pitch of 1. In other words, the coil U6 is disposed in the slots having slot identification numbers 33 and 36, upon being shaped so that currents flow in opposite directions through the winding disposed in the slot having slot identification number 33 and the winding disposed in the slot having slot identification number 36.

The above-mentioned coils U1, U2, U3, U4, U5, and U6 are connected to each other via a crossover line and serve as U-phase windings in the stator 1. The above-mentioned coils V1, V2, V3, V4, V5, and V6 are connected to each other via a crossover line and serve as V-phase windings in the stator 1. The above-mentioned coils W1, W2, W3, W4, W5, and W6 are connected to each other via a crossover line and serve as W-phase windings in the stator 1. The 10-pole, 36-slot three-phase AC motor includes the above-mentioned stator 1, and a rotor facing the stator 1 in the radial direction.

In this manner, in the 10-pole, 36-slot three-phase AC motor, a winding arrangement that allows single-layer winding of one coil per slot is always present. Therefore, the number of coils involved in the stator configuration is kept smaller. By dividing the coils into the first group of coils to the sixth group of coils and disposing them, portions where the coil ends do not overlap each other are formed every 60 degrees in the circumferential direction of the stator, instead of full circle winding, and no operation for interchanging coils, as in the conventional lap winding, is involved in inserting the coils into the stator. In other words, a winding operation can easily be automated. In addition, the coil pitch (=Quotient, That Is, Decimal Integer Part of Value Obtained by (Number of Slots)/(Number of Poles)) is 3. This means that a relatively small value is obtained as the coil pitch of distributed winding, and the coil ends can thus be formed short.

In lap winding in which single-layer winding of one coil per slot is formed, since only a winding of one phase of a three-phase alternating current is present in the slot, no insulating paper for insulating the phases from each other in the slot is involved.

For the coil ends of lap winding in which single-layer winding of one coil per slot is formed, since two or more adjacent coil ends are arranged parallel to each other, interphase insulating paper can easily be inserted at each coil end.

Since the first group of coils to the sixth group of coils are arranged in the slots of the stator every 60 degrees, the number of slots of the stator targeted in the present invention is limited to multiples of 6.

Regarding the specifications of the coil pitch and the number of continuous coils for implementing the embodiment of the present disclosure, an experiment on a three-phase AC motor formed by a combination of the number of poles 2P and the number of slots 6N revealed that the following three modes (I) to (III) are available. These modes (I) to (III) correspond to requirements of the number of slots and the number of poles for applying the embodiment of the present disclosure.

Mode (I): For 0.5<N/P<1 (or 1.5<(Number of Slots)/(Number of Poles)<3), Coil Pitch =2, Number of Continuous Coils=2, and Number of Slots Occupied by Continuous Lap Winding=4.

Mode (II): For 1<N/P<2 (or 3<(Number of Slots)/(Number of Poles)<4), Coil Pitch=3, Number of Continuous Coils=3, and Number of Slots Occupied by Continuous Lap Winding =6.

Mode (III): For N/P>2 (or (Number of Slots)/(Number of Poles)>4), any method for lap winding that allows single-layer winding per slot is unavailable. In other words, the embodiment of the present disclosure is not applicable in this mode.

In the above-mentioned modes (I) to (III), N is the value obtained by dividing the number of slots 6N by 6 and takes an integer, and P is an odd number of 5 or more.

In the 10-pole, 36-slot three-phase AC motor, the value obtained by dividing the number of slots of 36 by the number of poles of 10 is 3.6, and the motor corresponds to the above-mentioned mode (II). In fact, in the 10-pole, 36-slot three-phase AC motor illustrated in FIGS. 1 to 3, the coil pitch is 3, the number of continuous coils is 3, and the number of slots occupied by continuous lap winding is 6.

The symmetry of the winding arrangement in the stator according to the embodiment of the present disclosure will be described below.

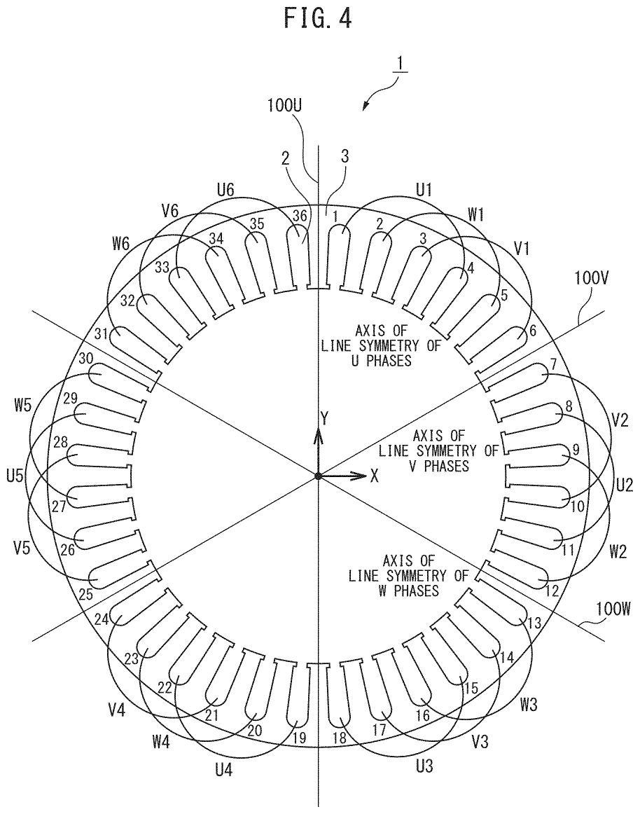

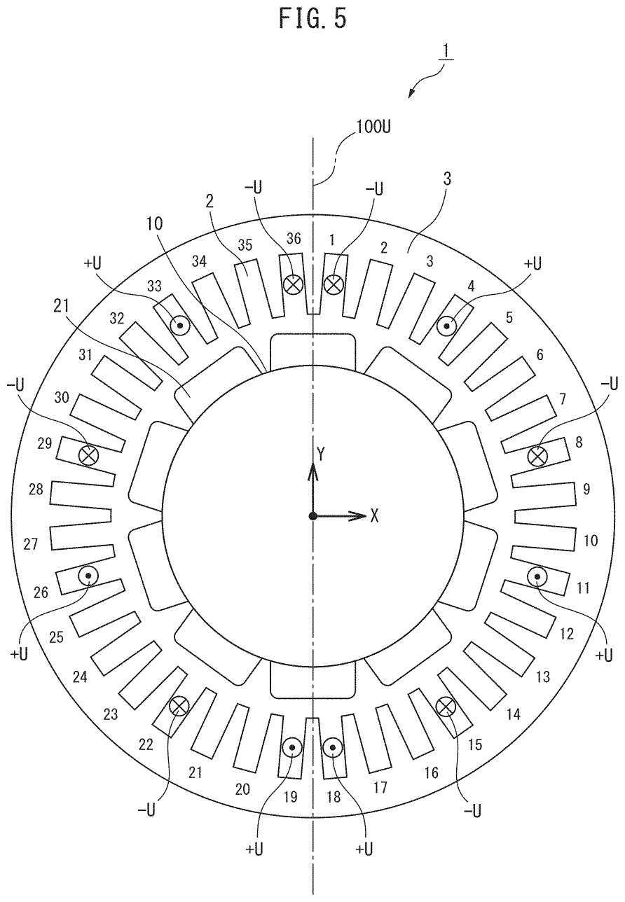

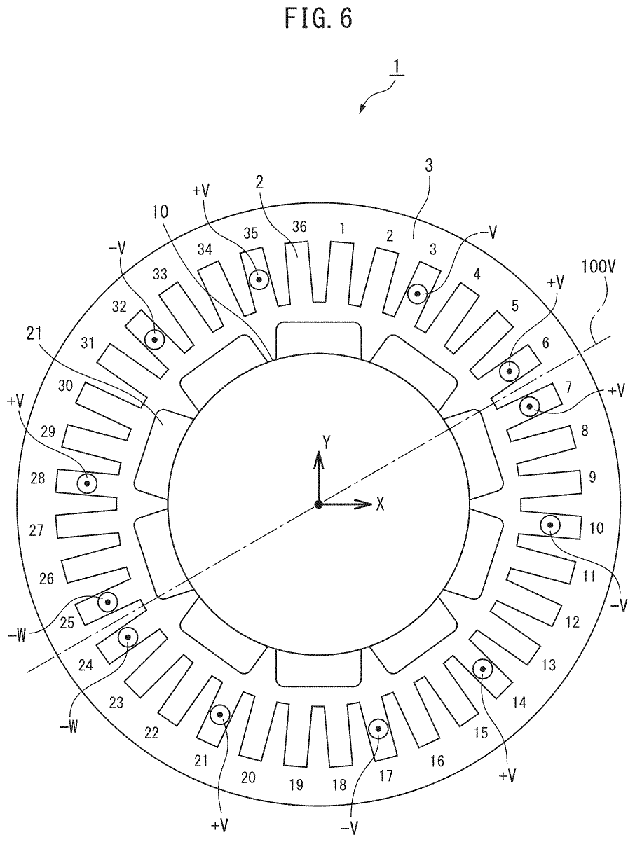

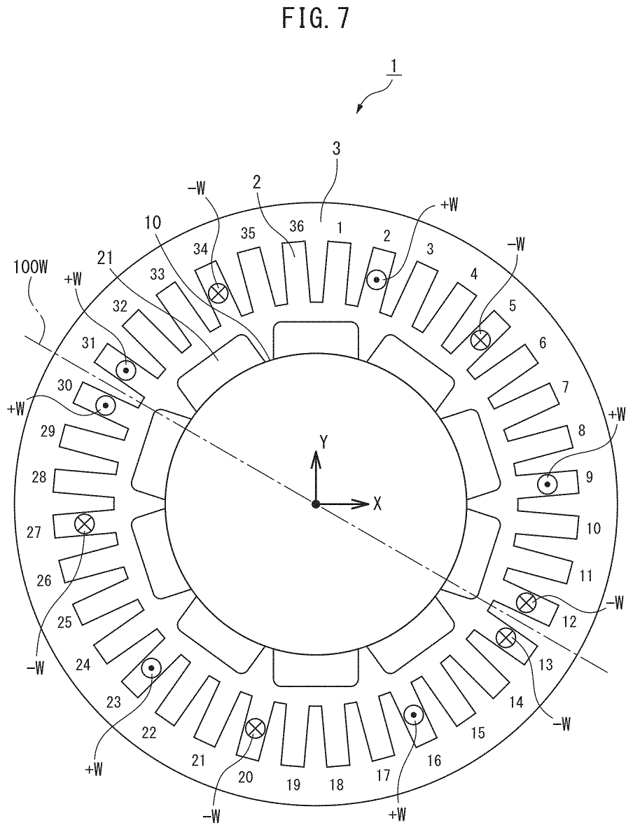

FIG. 4 is a sectional view for explaining the symmetry of the winding arrangement of the stator in the 10-pole, 36-slot three-phase AC motor illustrated in FIG. 1. FIG. 5 is a sectional view for explaining the symmetry of U-phase windings of the stator illustrated in FIG. 4. FIG. 6 is a sectional view for explaining the symmetry of V-phase windings of the stator illustrated in FIG. 4. FIG. 7 is a sectional view for explaining the symmetry of W-phase windings of the stator illustrated in FIG. 4. The magnetic poles 21 on the rotor 10 are also illustrated in FIGS. 5 to 7.

In the stator of the 10-pole, 36-slot three-phase AC motor illustrated in FIG. 1, the first-phase windings (U-phase windings) in the first group of coils U1, the second group of coils U2, and the third group of coils U3 and the first-phase windings (U-phase windings) in the sixth group of coils U6, the fifth group of coils U5, and the fourth group of coils U4 are arranged in line symmetry with respect to a first axis of symmetry 100U on the circumferential plane of the stator 1, as illustrated in FIGS. 4 and 5. The second-phase windings (V-phase windings) in the second group of coils V2, the third group of coils V3, and the fourth group of coils V4 and the second-phase windings (V-phase windings) in the first group of coils V1, the sixth group of coils V6, and the fifth group of coils V5 are arranged in line symmetry with respect to a second axis of symmetry 100V on the circumferential plane of the stator 1, as illustrated in FIGS. 4 and 6. The third-phase windings (W-phase windings) in the third group of coils W3, the fourth group of coils W4, and the fifth group of coils W5 and the third-phase windings (W-phase windings) in the second group of coils W2, the first group of coils W1, and the sixth group of coils W6 are arranged in line symmetry with respect to a third axis of symmetry 100W on the circumferential plane of the stator 1, as illustrated in FIGS. 4 and 7. The first axis of symmetry 100U, the second axis of symmetry 100V, and the third axis of symmetry 100W are shifted from each other by 60 degrees.

In a fractional-slot three-phase AC motor in which the number of slots is larger than 1.5 times the number of poles, and the value obtained by dividing the number of slots by the number of poles takes an irreducible fraction, when the number of pole pairs (=(Number of Poles)/2) on a rotor is an odd number of 5 or more, the symmetry of the winding arrangement, as described above, exists.

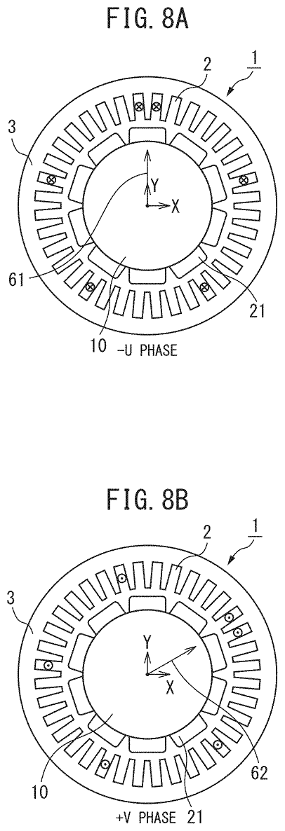

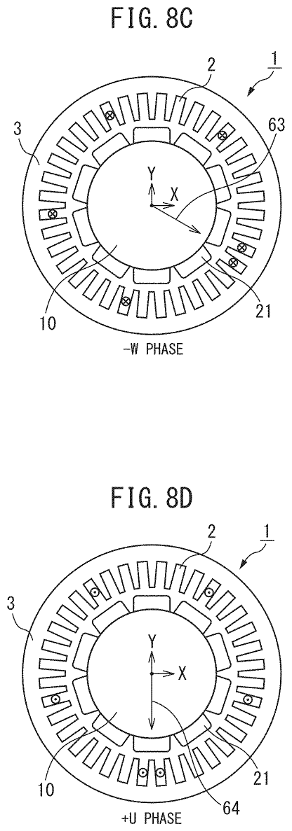

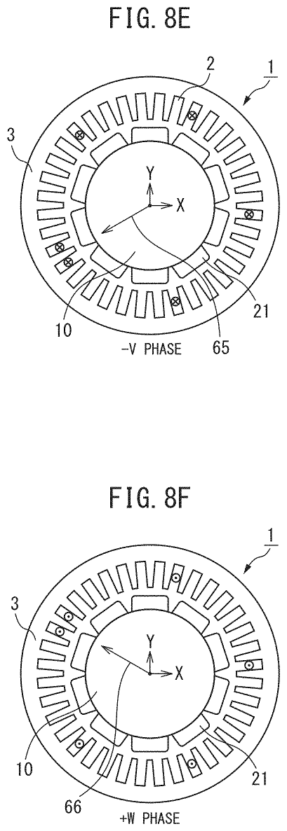

FIG. 8A is a sectional view (part 2) for explaining the symmetry of the winding arrangement of the stator in the 10-pole, 36-slot three-phase AC motor illustrated in FIG. 1, and depicts a −U-phase belt winding arrangement. FIG. 8B is a sectional view (part 2) for explaining the symmetry of the winding arrangement of the stator in the 10-pole, 36-slot three-phase AC motor illustrated in FIG. 1, and depicts a +V-phase belt winding arrangement. FIG. 8C is a sectional view (part 2) for explaining the symmetry of the winding arrangement of the stator in the 10-pole, 36-slot three-phase AC motor illustrated in FIG. 1, and depicts a −W-phase belt winding arrangement. FIG. 8D is a sectional view (part 2) for explaining the symmetry of the winding arrangement of the stator in the 10-pole, 36-slot three-phase AC motor illustrated in FIG. 1, and depicts a +U-phase belt winding arrangement. FIG. 8E is a sectional view (part 2) for explaining the symmetry of the winding arrangement of the stator in the 10-pole, 36-slot three-phase AC motor illustrated in FIG. 1, and depicts a −V-phase belt winding arrangement. FIG. 8F is a sectional view (part 2) for explaining the symmetry of the winding arrangement of the stator in the 10-pole, 36-slot three-phase AC motor illustrated in FIG. 1, and depicts a +W-phase belt winding arrangement. Referring to FIG. 8A, reference numeral 61 denotes a −U-phase belt axis of line symmetry, and represents a vector pointing in the arrangement direction. Referring to FIG. 8B, reference numeral 62 denotes a +V-phase belt axis of line symmetry, and represents a vector pointing in the arrangement direction. Referring to FIG. 8C, reference numeral 63 denotes a −W-phase belt axis of line symmetry, and represents a vector pointing in the arrangement direction. Referring to FIG. 8D, reference numeral 64 denotes a +U-phase belt axis of line symmetry, and represents a vector pointing in the arrangement direction. Referring to FIG. 8E, reference numeral 65 denotes a −V-phase belt axis of line symmetry, and represents a vector pointing in the arrangement direction. Referring to FIG. 8F, reference numeral 66 denotes a +W-phase belt axis of line symmetry, and represents a vector pointing in the arrangement direction.

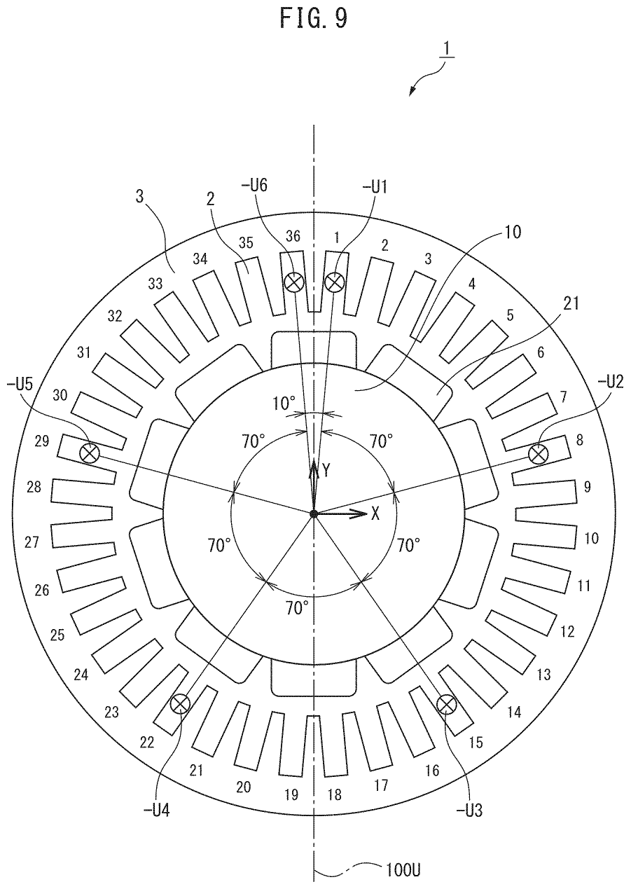

FIG. 9 is a sectional view illustrating the −U-phase belt winding arrangement depicted in FIG. 8A. In the stator 1 of the 10-pole, 36-slot three-phase AC motor, for the windings of the same phase belt (in the example illustrated in FIG. 9, the −U-phase belt), the slot pitch to an adjacent winding is 70 degrees at five positions and 10 degrees at one position. In other words, in a stator for a fractional-slot three-phase AC motor in which the value obtained by dividing the number of slots by the number of poles takes an irreducible fraction, the winding arrangement has windings that are not distributed at equal angles, i.e., has no rotational symmetry. When the number of pole pairs is an odd number of 5 or more, an axis of line symmetry is always present. This is for the following reason.

For each of the six phase belts: ±U, ±V, and ±W, when the winding arrangement is optimized to approximate the waveform of an induced voltage generated in the coils of the stator to a sinusoidal wave, the windings of each phase belt are arranged in a uniform distribution at a slot pitch close to the value of 360/(Number of Pole Pairs P), and are therefore arranged in a shape close to a regular P-sided polygon (where P is the number of pole pairs).

Generally, when the number of pole pairs P is an odd number, the regular P-sided polygon has not only P-fold rotational symmetry, but also line symmetry with respect to a perpendicular line passing from each vertex to the center of the opposite side of this vertex.

When windings of one phase among the six phase belts: ±U, ±V, and ±W are disposed in slots of a fractional-slot stator, they are arranged in a shape close to a regular P-sided polygon having P vertices, where P is an odd number. The winding arrangement may not have rotational symmetry, but since “P−1” always takes an even number, (P−1)/2 continuous vertices and (P−1)/2 consecutive vertices adjacent to the first vertices are arranged in line symmetry, except a certain vertex of the P vertices. The line of line symmetry passes through the remaining vertex.

The 10-pole, 36-slot three-phase AC motor having the winding arrangement of FIG. 2 will be taken as an example herein with reference to FIG. 9. FIG. 9 represents a −U-phase winding arrangement among the six phase belts: ±U, ±V, and ±W. A total of six −U-phase windings: −U1, −U2, −U3, −U4, −U5, and −U6 are used, and the arrangement of the six −U-phase windings forms a shape close to a regular pentagon assuming the adjacent −U1- and −U6-phase windings as one combined winding.

Since the number of pole pairs on the rotor for the −U-phase windings is 5, the period of one pole pair corresponding to 360 electrical degrees corresponds to 360/5=72 mechanical degrees. Since the number of slots is 36, a slot pitch of 1 is equivalent to 360/36=10 degrees. The slot pitch from one −U-phase winding to an adjacent −U-phase winding is desirably set to 72 mechanical degrees corresponding to one period of the electrical angle. The slot pitch, however, can be set to only 10 degrees corresponding to one slot between −U6 and −U1, and only 70 degrees corresponding to seven slots and close to 72 degrees between −U1 and −U2, −U2 and −U3, −U3 and −U4, −U4 and −U5, and −U5 and −U6. Therefore, the −U-phase winding arrangement has no rotational symmetry. From distribution uniformity of the windings, two windings (−U2 and −U3) and two successive windings (−U4 and −U5) among the six −U-phase windings are arranged in line symmetry with respect to 100U as an axis of line symmetry. The axis of line symmetry 100U also serves as the axis of line symmetry between −U1 and −U6, and, as a consequence, can be said to be an axis of line symmetry bisecting the six −U-phase windings. For the same reason, the winding arrangements of the remaining five phase belts have no rotational symmetry, but they have axes of line symmetry as well. In the 10-pole, 36-slot three-phase AC motor, further, the axis of line symmetry 100U for the −U and +U phases, the axis of line symmetry 100V for the −V and +V phases, and the axis of line symmetry 100W for the −W and +W phases coincide with lines dividing the groups of coils.

The above-described line symmetry of the windings can be summarized as follows: U-phase windings are arranged to have one axis of line symmetry, V-phase windings are arranged to have one axis of line symmetry, and W-phase windings are arranged to have one axis of line symmetry. In other words, U-phase windings are arranged in line symmetry with respect to the axis of line symmetry 100U, V-phase windings are arranged in line symmetry with respect to the axis of line symmetry 100V, and W-phase windings are arranged in line symmetry with respect to the axis of line symmetry 100W. This is a feature of a three-phase AC motor in which the number of pole pairs P is an odd number, and the value obtained by dividing the number of slots by the number of poles takes an irreducible fraction.

Since the coil ends of the coils simply connect positive phases of windings to negative phases of windings close to the former windings, whether the axes of line symmetry of the windings coincide with the division lines of the six groups of coils depends on the combination of the number of poles and the number of slots. When mode (I) holds, the axis of line symmetry of each phase does not coincide with any division line of the groups of coils. When mode (II) holds, the axis of line symmetry of each phase is known to coincide with any division line of the groups of coils. This is for the following reason: in mode (I), since the number of continuous coils of lap winding is 2, and two of the three phases are assigned to the two coils of one lap winding set, the three phases are nonuniform in this lap winding set. Therefore, an axis of line symmetry of one phase is located to segment lap winding sets of the remaining two phases in the middle, and crosses the coil ends of the coils of these remaining two phases. In contrast to this, in mode (II), since the number of continuous coils of lap winding is 3, and all the three phases are uniformly assigned to each lap winding set, the division lines of the groups of coils equally dividing the slots always coincide with the axes of line symmetry of the respective phases.

In fact, in the 10-pole, 36-slot three-phase AC motor, the axes of line symmetry 100U, 100V, and 100W of the windings of the respective phases coincide with lines dividing the first to sixth groups of coils.

A stator in a 10-pole, 24-slot three-phase AC motor will be described below.

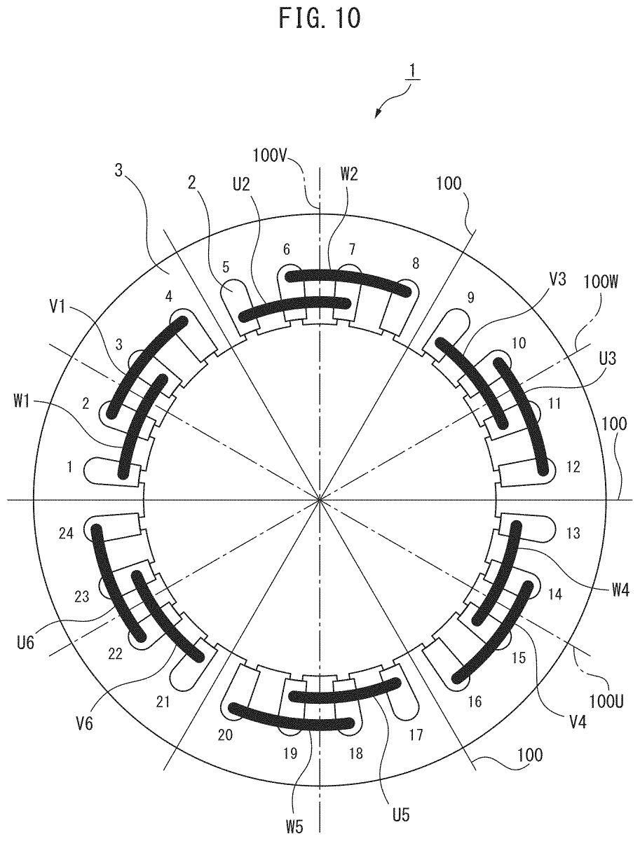

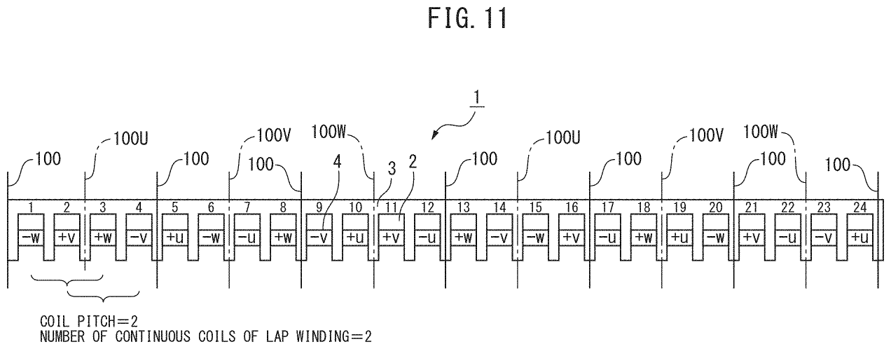

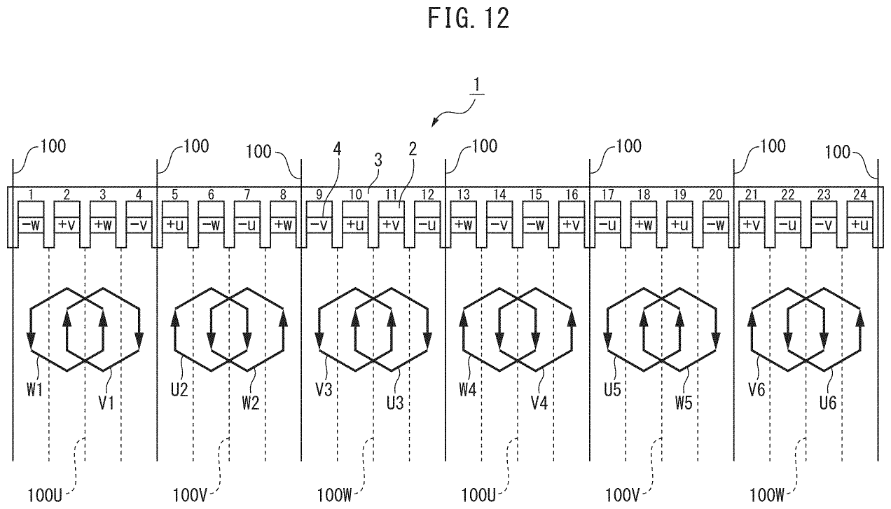

FIG. 10 is a sectional view illustrating a stator in a 10-pole, 24-slot three-phase AC motor according to an embodiment of the present disclosure. FIG. 11 is a developed sectional view of the stator illustrated in FIG. 10. FIG. 12 is a developed sectional view for explaining each coil arrangement in the stator illustrated in FIG. 11. Magnetic poles on a rotor are not illustrated in FIGS. 10 to 12.

In the 10-pole, 24-slot three-phase AC motor, since the value obtained by dividing the number of slots of 24 by the number of poles of 10 is 2.4, the motor satisfies the requirement “the number of slots is larger than 1.5 times the number of poles.” In addition, since 12/5 taken as the value obtained by dividing the number of slots of 24 by the number of poles of 10 is an irreducible fraction, the motor can be said to be of the fractional slot type.

The 10-pole, 24-slot three-phase AC motor corresponds to mode (I), in which the coil pitch is 2, and the number of continuous coils is 2. Hence, two coils each having a coil pitch of 2 are arranged in one set to be shifted from each other by a slot pitch of 1 and span four slots. Therefore, since the number of slots of the stator 1 is 24, the respective coils of the U, V, and W phases are arranged as equally divided into six groups of coils throughout all the 24 slots, thus allowing lap winding in each group. The two coils of each of these lap winding sets respectively serve as two of a U-phase winding defined as a first-phase winding, a V-phase winding defined as a second-phase winding, and a W-phase winding defined as a third-phase winding.

In the first group of coils, two coils W1 and V1 having the same coil pitch are arranged in slots shifted from each other by a slot pitch of 1. More specifically, the coil W1 is disposed in the slots having slot identification numbers 1 and 3, upon being shaped so that currents flow in opposite directions through the winding disposed in the slot having slot identification number 1 and the winding disposed in the slot having slot identification number 3 shifted from the slot having slot identification number 1 by a coil pitch of 2. The coil V1 is disposed in slots shifted from those of the coil W1 by a slot pitch of 1. In other words, the coil V1 is disposed in the slots having slot identification numbers 2 and 4, upon being shaped so that currents flow in opposite directions through the winding disposed in the slot having slot identification number 2 and the winding disposed in the slot having slot identification number 4.

In the second group of coils, two coils U2 and W2 having the same coil pitch are arranged in slots shifted from each other by a slot pitch of 1. The second group of coils is shifted in position from the first group of coils by 60 degrees in the circumferential direction (in the example illustrated in FIG. 10, clockwise). More specifically, the coil U2 is disposed in the slots having slot identification numbers 5 and 7, upon being shaped so that currents flow in opposite directions through the winding disposed in the slot having slot identification number 5 and the winding disposed in the slot having slot identification number 7. The coil W2 is disposed in slots shifted from those of the coil U2 by a slot pitch of 1. In other words, the coil W2 is disposed in the slots having slot identification numbers 6 and 8, upon being shaped so that currents flow in opposite directions through the winding disposed in the slot having slot identification number 6 and the winding disposed in the slot having slot identification number 8.

In the third group of coils, two coils V3 and U3 having the same coil pitch are arranged in slots shifted from each other by a slot pitch of 1. The third group of coils is shifted in position from the second group of coils by 60 degrees in the same direction (i.e., clockwise) as the above-mentioned circumferential direction. More specifically, the coil V3 is disposed in the slots having slot identification numbers 9 and 11, upon being shaped so that currents flow in opposite directions through the winding disposed in the slot having slot identification number 9 and the winding disposed in the slot having slot identification number 11. The coil U3 is disposed in slots shifted from those of the coil V3 by a slot pitch of 1. In other words, the coil U3 is disposed in the slots having slot identification numbers 10 and 12, upon being shaped so that currents flow in opposite directions through the winding disposed in the slot having slot identification number 10 and the winding disposed in the slot having slot identification number 12.

In the fourth group of coils, two coils W4 and V4 having the same coil pitch are arranged in slots shifted from each other by a slot pitch of 1. The fourth group of coils is shifted in position from the third group of coils by 60 degrees in the same direction (i.e., clockwise) as the above-mentioned circumferential direction. More specifically, the coil W4 is disposed in the slots having slot identification numbers 13 and 15, upon being shaped so that currents flow in opposite directions through the winding disposed in the slot having slot identification number 13 and the winding disposed in the slot having slot identification number 15. The coil V4 is disposed in slots shifted from those of the coil W4 by a slot pitch of 1. In other words, the coil V4 is disposed in the slots having slot identification numbers 14 and 16, upon being shaped so that currents flow in opposite directions through the winding disposed in the slot having slot identification number 14 and the winding disposed in the slot having slot identification number 16.

In the fifth group of coils, two coils U5 and W5 having the same coil pitch are arranged in slots shifted from each other by a slot pitch of 1. The fifth group of coils is shifted in position from the fourth group of coils by 60 degrees in the same direction (i.e., clockwise) as the above-mentioned circumferential direction. More specifically, the coil U5 is disposed in the slots having slot identification numbers 17 and 19, upon being shaped so that currents flow in opposite directions through the winding disposed in the slot having slot identification number 17 and the winding disposed in the slot having slot identification number 19. The coil W5 is disposed in slots shifted from those of the coil U5 by a slot pitch of 1. In other words, the coil W5 is disposed in the slots having slot identification numbers 18 and 20, upon being shaped so that currents flow in opposite directions through the winding disposed in the slot having slot identification number 18 and the winding disposed in the slot having slot identification number 20.

In the sixth group of coils, two coils V6 and U6 having the same coil pitch are arranged in slots shifted from each other by a slot pitch of 1. The sixth group of coils is shifted in position from the fifth group of coils by 60 degrees in the same direction (i.e., clockwise) as the above-mentioned circumferential direction. More specifically, the coil V6 is disposed in the slots having slot identification numbers 21 and 23, upon being shaped so that currents flow in opposite directions through the winding disposed in the slot having slot identification number 21 and the winding disposed in the slot having slot identification number 23. The coil U6 is disposed in slots shifted from those of the coil V6 by a slot pitch of 1. In other words, the coil U6 is disposed in the slots having slot identification numbers 22 and 24, upon being shaped so that currents flow in opposite directions through the winding disposed in the slot having slot identification number 22 and the winding disposed in the slot having slot identification number 24.

The above-mentioned coils U2, U3, U5, and U6 are connected to each other via a crossover line and serve as U-phase windings in the stator 1. The above-mentioned coils V1, V3, V4, and V6 are connected to each other via a crossover line and serve as V-phase windings in the stator 1. The above-mentioned coils W1, W2, W4, and W5 are connected to each other via a crossover line and serve as W-phase windings in the stator 1. The 10-pole, 24-slot three-phase AC motor includes the above-mentioned stator 1, and a rotor facing the stator 1 in the radial direction.

None of the axes of line symmetry 100U, 100V, and 100W of the windings of the respective phases coincide with any lines 100 dividing the first to sixth groups of coils.

A stator in a 14-pole, 24-slot three-phase AC motor will be described below.

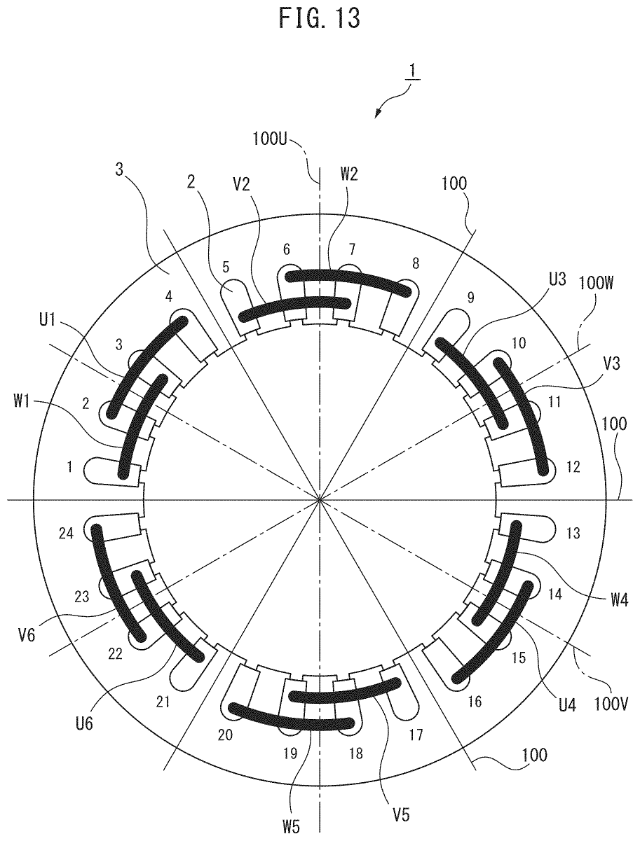

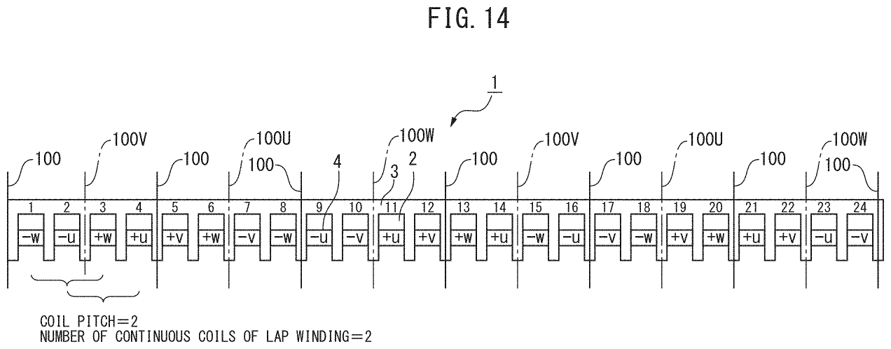

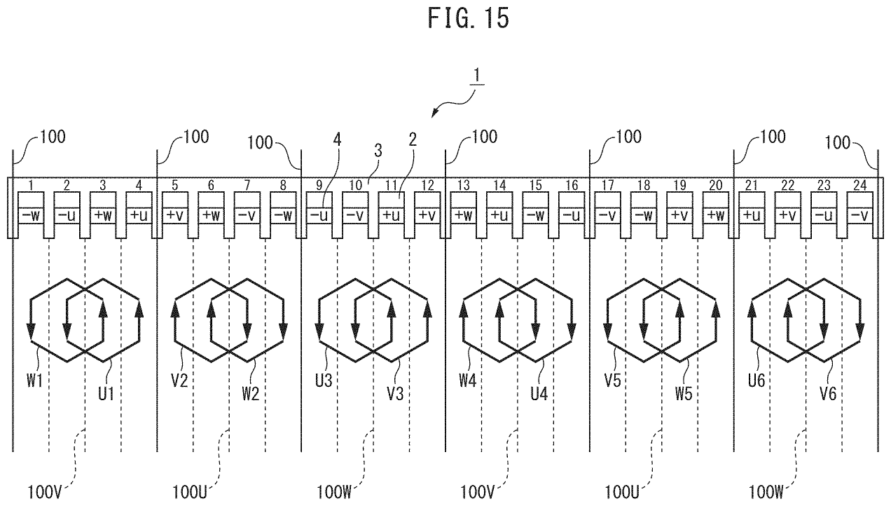

FIG. 13 is a sectional view illustrating a stator in a 14-pole, 24-slot three-phase AC motor according to an embodiment of the present disclosure. FIG. 14 is a developed sectional view of the stator illustrated in FIG. 13. FIG. 15 is a developed sectional view for explaining each coil arrangement in the stator illustrated in FIG. 13. Magnetic poles on a rotor are not illustrated in FIGS. 13 to 15.

In the 14-pole, 24-slot three-phase AC motor, since the value obtained by dividing the number of slots of 24 by the number of poles of 14 is about 1.7, the motor satisfies the requirement “the number of slots is larger than 1.5 times the number of poles.” In addition, since 12/7 taken as the value obtained by dividing the number of slots of 24 by the number of poles of 14 is an irreducible fraction, the motor can be said to be of the fractional slot type.

In the 14-pole, 24-slot three-phase AC motor, since the value obtained by dividing the number of slots of 24 by the number of poles of 14 is about 1.7, the motor corresponds to mode (I), in which the coil pitch is 2, and the number of continuous coils is 2, as illustrated in FIG. 14. Hence, two coils each having a coil pitch of 2 are arranged in one set to be shifted from each other by a slot pitch of 1 and span four slots. Therefore, the respective coils of the U, V, and W phases are arranged as equally divided into six groups of coils throughout all the 24 slots, thus allowing separate lap winding in each group of coils. The two coils of each of these lap winding sets respectively serve as two of a U-phase winding defined as a first-phase winding, a V-phase winding defined as a second-phase winding, and a W-phase winding defined as a third-phase winding.

In the first group of coils, two coils W1 and U1 having the same coil pitch are arranged in slots shifted from each other by a slot pitch of 1. More specifically, the coil W1 is disposed in the slots having slot identification numbers 1 and 3, upon being shaped so that currents flow in opposite directions through the winding disposed in the slot having slot identification number 1 and the winding disposed in the slot having slot identification number 3 shifted from the slot having slot identification number 1 by a coil pitch of 2. The coil U1 is disposed in slots shifted from those of the coil W1 by a slot pitch of 1. In other words, the coil U1 is disposed in the slots having slot identification numbers 2 and 4, upon being shaped so that currents flow in opposite directions through the winding disposed in the slot having slot identification number 2 and the winding disposed in the slot having slot identification number 4.

In the second group of coils, two coils V2 and W2 having the same coil pitch are arranged in slots shifted from each other by a slot pitch of 1. The second group of coils is shifted in position from the first group of coils by 60 degrees in the circumferential direction (in the example illustrated in FIG. 13, clockwise). More specifically, the coil V2 is disposed in the slots having slot identification numbers 5 and 7, upon being shaped so that currents flow in opposite directions through the winding disposed in the slot having slot identification number 5 and the winding disposed in the slot having slot identification number 7. The coil W2 is disposed in slots shifted from those of the coil U2 by a slot pitch of 1. In other words, the coil W2 is disposed in the slots having slot identification numbers 6 and 8, upon being shaped so that currents flow in opposite directions through the winding disposed in the slot having slot identification number 6 and the winding disposed in the slot having slot identification number 8.

In the third group of coils, two coils U3 and V3 having the same coil pitch are arranged in slots shifted from each other by a slot pitch of 1. The third group of coils is shifted in position from the second group of coils by 60 degrees in the same direction (i.e., clockwise) as the above-mentioned circumferential direction. More specifically, the coil U3 is disposed in the slots having slot identification numbers 9 and 11, upon being shaped so that currents flow in opposite directions through the winding disposed in the slot having slot identification number 9 and the winding disposed in the slot having slot identification number 11. The coil V3 is disposed in slots shifted from those of the coil U3 by a slot pitch of 1. In other words, the coil V3 is disposed in the slots having slot identification numbers 10 and 12, upon being shaped so that currents flow in opposite directions through the winding disposed in the slot having slot identification number 10 and the winding disposed in the slot having slot identification number 12.

In the fourth group of coils, two coils W4 and U4 having the same coil pitch are arranged in slots shifted from each other by a slot pitch of 1. The fourth group of coils is shifted in position from the third group of coils by 60 degrees in the same direction (i.e., clockwise) as the above-mentioned circumferential direction. More specifically, the coil W4 is disposed in the slots having slot identification numbers 13 and 15, upon being shaped so that currents flow in opposite directions through the winding disposed in the slot having slot identification number 13 and the winding disposed in the slot having slot identification number 15. The coil U4 is disposed in slots shifted from those of the coil W4 by a slot pitch of 1. In other words, the coil U4 is disposed in the slots having slot identification numbers 14 and 16, upon being shaped so that currents flow in opposite directions through the winding disposed in the slot having slot identification number 14 and the winding disposed in the slot having slot identification number 16.

In the fifth group of coils, two coils V5 and U5 having the same coil pitch are arranged in slots shifted from each other by a slot pitch of 1. The fifth group of coils is shifted in position from the fourth group of coils by 60 degrees in the same direction (i.e., clockwise) as the above-mentioned circumferential direction. More specifically, the coil V5 is disposed in the slots having slot identification numbers 17 and 19, upon being shaped so that currents flow in opposite directions through the winding disposed in the slot having slot identification number 17 and the winding disposed in the slot having slot identification number 19. The coil U5 is disposed in slots shifted from those of the coil V5 by a slot pitch of 1. In other words, the coil U5 is disposed in the slots having slot identification numbers 18 and 20, upon being shaped so that currents flow in opposite directions through the winding disposed in the slot having slot identification number 18 and the winding disposed in the slot having slot identification number 20.

In the sixth group of coils, two coils U6 and V6 having the same coil pitch are arranged in slots shifted from each other by a slot pitch of 1. The sixth group of coils is shifted in position from the fifth group of coils by 60 degrees in the same direction (i.e., clockwise) as the above-mentioned circumferential direction. More specifically, the coil U6 is disposed in the slots having slot identification numbers 21 and 23, upon being shaped so that currents flow in opposite directions through the winding disposed in the slot having slot identification number 21 and the winding disposed in the slot having slot identification number 23. The coil V6 is disposed in slots shifted from those of the coil U6 by a slot pitch of 1. In other words, the coil V6 is disposed in the slots having slot identification numbers 22 and 24, upon being shaped so that currents flow in opposite directions through the winding disposed in the slot having slot identification number 22 and the winding disposed in the slot having slot identification number 24.

The above-mentioned coils U1, U3, U5, and U6 are connected to each other via a crossover line and serve as U-phase windings in the stator 1. The above-mentioned coils V2, V3, V5, and V6 are connected to each other via a crossover line and serve as V-phase windings in the stator 1. The above-mentioned coils W1, W2, W4, and W6 are connected to each other via a crossover line and serve as W-phase windings in the stator 1. The 14-pole, 24-slot three-phase AC motor includes the above-mentioned stator 1, and a rotor facing the stator 1 in the radial direction.

None of the axes of line symmetry 100U, 100V, and 100W of the windings of the respective phases coincide with any lines 100 dividing the first to sixth groups of coils.

A stator in a 22-pole, 48-slot three-phase AC motor will be described below.

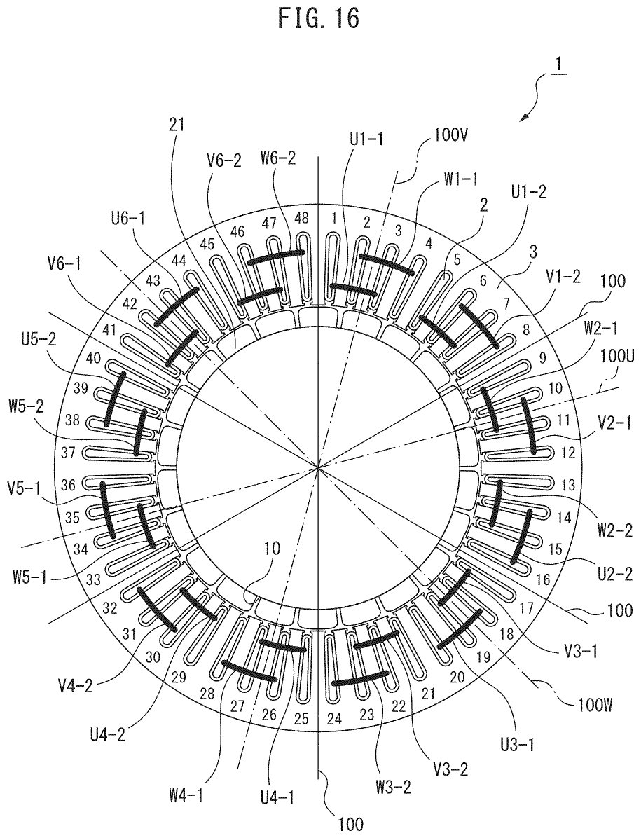

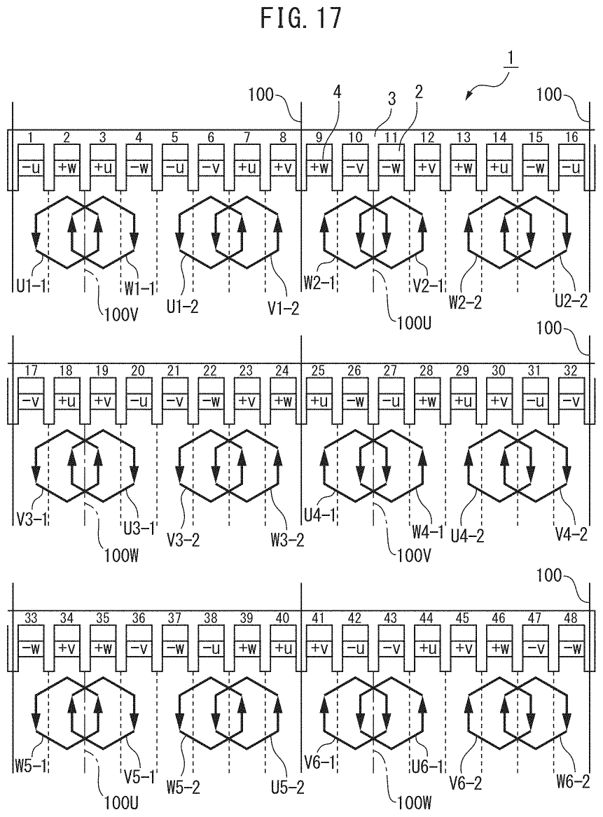

FIG. 16 is a sectional view illustrating a stator in a 22-pole, 48-slot three-phase AC motor according to an embodiment of the present disclosure. FIG. 17 is a developed sectional view of the stator illustrated in FIG. 16.

In the 22-pole, 48-slot three-phase AC motor, since the value obtained by dividing the number of slots of 48 by the number of poles of 22 is about 2.2, the motor satisfies the requirement “the number of slots is larger than 1.5 times the number of poles.” In addition, since 24/11 taken as the value obtained by dividing the number of slots of 48 by the number of poles of 22 is an irreducible fraction, the motor can be said to be of the fractional slot type.

The 22-pole, 48-slot three-phase AC motor corresponds to mode (I), in which the coil pitch is 2, and the number of continuous coils is 2. Hence, two coils each having a coil pitch of 2 are arranged in one lap winding set to be shifted from each other by a slot pitch of 1 and span four slots. Another lap winding set, which is formed by two continuous coils each having a coil pitch of 2 and spans four slots, is disposed to be shifted from the first lap winding set by four slots in the circumferential direction, and a total of two lap winding sets thus span eight slots. Upon setting these two lap winding sets as one group of coils, such groups of coils are arranged as equally divided into six groups of coils throughout all the 48 slots, thus allowing separate lap winding in each group of coils. The two coils of each lap winding set respectively serve as windings of two phases among a U-phase winding defined as a first-phase winding, a V-phase winding defined as a second-phase winding, and a W-phase winding defined as a third-phase winding.

In the first group of coils, one lap winding set in which two coils U1-1 and W1-1 having the same coil pitch are arranged in slots shifted from each other by a slot pitch of 1 is formed, and another lap winding set in which two coils U1-2 and V1-2 having the same coil pitch are arranged in slots shifted from each other by a slot pitch of 1 is formed to be shifted from the first lap winding set by four slots in the circumferential direction. More specifically, the coil U1-1 is disposed in the slots having slot identification numbers 1 and 3, upon being shaped so that currents flow in opposite directions through the winding disposed in the slot having slot identification number 1 and the winding disposed in the slot having slot identification number 3 shifted from the slot having slot identification number 1 by a coil pitch of 2. The coil W1-1 is disposed in slots shifted from those of the coil U1-1 by a slot pitch of 1. In other words, the coil W1-1 is disposed in the slots having slot identification numbers 2 and 4, upon being shaped so that currents flow in opposite directions through the winding disposed in the slot having slot identification number 2 and the winding disposed in the slot having slot identification number 4 shifted from the slot having slot identification number 2 by a coil pitch of 2. The coil U1-2 is disposed in slots shifted from those of the coil U1-1 by a slot pitch of 4. In other words, the coil U1-2 is disposed in the slots having slot identification numbers 5 and 7, upon being shaped so that currents flow in opposite directions through the winding disposed in the slot having slot identification number 5 and the winding disposed in the slot having slot identification number 7 shifted from the slot having slot identification number 5 by a coil pitch of 2. The coil V1-2 is disposed in slots shifted from those of the coil U1-2 by a slot pitch of 1. In other words, the coil V1-2 is disposed in the slots having slot identification numbers 6 and 8, upon being shaped so that currents flow in opposite directions through the winding disposed in the slot having slot identification number 6 and the winding disposed in the slot having slot identification number 8 shifted from the slot having slot identification number 6 by a coil pitch of 2.

In the second group of coils, one lap winding set in which two coils W2-1 and V2-1 having the same coil pitch are arranged in slots shifted from each other by a slot pitch of 1 is formed, and another lap winding set in which two coils W2-2 and U2-2 having the same coil pitch are arranged in slots shifted from each other by a slot pitch of 1 is formed to be shifted from the first lap winding set by four slots in the circumferential direction. The second group of coils is shifted in position from the first group of coils by 60 degrees in the circumferential direction (in the example illustrated in FIG. 16, clockwise). More specifically, the coil W2-1 is disposed in the slots having slot identification numbers 9 and 11, upon being shaped so that currents flow in opposite directions through the winding disposed in the slot having slot identification number 9 and the winding disposed in the slot having slot identification number 11 shifted from the slot having slot identification number 9 by a coil pitch of 2. The coil V2-1 is disposed in slots shifted from those of the coil W2-1 by a slot pitch of 1. In other words, the coil V2-1 is disposed in the slots having slot identification numbers 10 and 12, upon being shaped so that currents flow in opposite directions through the winding disposed in the slot having slot identification number 10 and the winding disposed in the slot having slot identification number 12 shifted from the slot having slot identification number 10 by a coil pitch of 2. The coil W2-2 is disposed in slots shifted from those of the coil W2-1 by a slot pitch of 4. In other words, the coil W2-2 is disposed in the slots having slot identification numbers 13 and 15, upon being shaped so that currents flow in opposite directions through the winding disposed in the slot having slot identification number 13 and the winding disposed in the slot having slot identification number 15 shifted from the slot having slot identification number 13 by a coil pitch of 2. The coil U2-2 is disposed in slots shifted from those of the coil W2-2 by a slot pitch of 1. In other words, the coil U2-2 is disposed in the slots having slot identification numbers 14 and 16, upon being shaped so that currents flow in opposite directions through the winding disposed in the slot having slot identification number 14 and the winding disposed in the slot having slot identification number 16 shifted from the slot having slot identification number 14 by a coil pitch of 2.

In the third group of coils, one lap winding set in which two coils V3-1 and U3-1 having the same coil pitch are arranged in slots shifted from each other by a slot pitch of 1 is formed, and another lap winding set in which two coils V3-2 and W3-2 having the same coil pitch are arranged in slots shifted from each other by a slot pitch of 1 is formed to be shifted from the first lap winding set by four slots in the circumferential direction. The third group of coils is shifted in position from the second group of coils by 60 degrees in the circumferential direction (in the example illustrated in FIG. 16, clockwise). More specifically, the coil V3-1 is disposed in the slots having slot identification numbers 17 and 19, upon being shaped so that currents flow in opposite directions through the winding disposed in the slot having slot identification number 17 and the winding disposed in the slot having slot identification number 19 shifted from the slot having slot identification number 17 by a coil pitch of 2. The coil U3-1 is disposed in slots shifted from those of the coil V3-1 by a slot pitch of 1. In other words, the coil U3-1 is disposed in the slots having slot identification numbers 18 and 20, upon being shaped so that currents flow in opposite directions through the winding disposed in the slot having slot identification number 18 and the winding disposed in the slot having slot identification number 20 shifted from the slot having slot identification number 18 by a coil pitch of 2. The coil V3-2 is disposed in slots shifted from those of the coil V3-1 by a slot pitch of 4. In other words, the coil V3-2 is disposed in the slots having slot identification numbers 21 and 23, upon being shaped so that currents flow in opposite directions through the winding disposed in the slot having slot identification number 21 and the winding disposed in the slot having slot identification number 23 shifted from the slot having slot identification number 21 by a coil pitch of 2. The coil W3-2 is disposed in slots shifted from those of the coil V3-2 by a slot pitch of 1. In other words, the coil W3-2 is disposed in the slots having slot identification numbers 22 and 24, upon being shaped so that currents flow in opposite directions through the winding disposed in the slot having slot identification number 22 and the winding disposed in the slot having slot identification number 24 shifted from the slot having slot identification number 22 by a coil pitch of 2.

In the fourth group of coils, one lap winding set in which two coils U4-1 and W4-1 having the same coil pitch are arranged in slots shifted from each other by a slot pitch of 1 is formed, and another lap winding set in which two coils U4-2 and V4-2 having the same coil pitch are arranged in slots shifted from each other by a slot pitch of 1 is formed to be shifted from the first lap winding set by four slots in the circumferential direction. The fourth group of coils is shifted in position from the third group of coils by 60 degrees in the circumferential direction (in the example illustrated in FIG. 16, clockwise). More specifically, the coil U4-1 is disposed in the slots having slot identification numbers 25 and 27, upon being shaped so that currents flow in opposite directions through the winding disposed in the slot having slot identification number 25 and the winding disposed in the slot having slot identification number 27 shifted from the slot having slot identification number 25 by a coil pitch of 2. The coil W4-1 is disposed in slots shifted from those of the coil U4-1 by a slot pitch of 1. In other words, the coil W4-1 is disposed in the slots having slot identification numbers 26 and 28, upon being shaped so that currents flow in opposite directions through the winding disposed in the slot having slot identification number 26 and the winding disposed in the slot having slot identification number 28 shifted from the slot having slot identification number 26 by a coil pitch of 2. The coil U4-2 is disposed in slots shifted from those of the coil U4-1 by a slot pitch of 4. In other words, the coil U4-2 is disposed in the slots having slot identification numbers 29 and 31, upon being shaped so that currents flow in opposite directions through the winding disposed in the slot having slot identification number 29 and the winding disposed in the slot having slot identification number 31 shifted from the slot having slot identification number 29 by a coil pitch of 2. The coil V4-2 is disposed in slots shifted from those of the coil U4-2 by a slot pitch of 1. In other words, the coil V4-2 is disposed in the slots having slot identification numbers 30 and 32, upon being shaped so that currents flow in opposite directions through the winding disposed in the slot having slot identification number 30 and the winding disposed in the slot having slot identification number 32 shifted from the slot having slot identification number 30 by a coil pitch of 2.

In the fifth group of coils, one lap winding set in which two coils W5-1 and V5-1 having the same coil pitch are arranged in slots shifted from each other by a slot pitch of 1 is formed, and another lap winding set in which two coils W5-2 and U5-2 having the same coil pitch are arranged in slots shifted from each other by a slot pitch of 1 is formed to be shifted from the first lap winding set by four slots in the circumferential direction. The fifth group of coils is shifted in position from the fourth group of coils by 60 degrees in the circumferential direction (in the example illustrated in FIG. 16, clockwise). More specifically, the coil W5-1 is disposed in the slots having slot identification numbers 33 and 35, upon being shaped so that currents flow in opposite directions through the winding disposed in the slot having slot identification number 33 and the winding disposed in the slot having slot identification number 35 shifted from the slot having slot identification number 33 by a coil pitch of 2. The coil V5-1 is disposed in slots shifted from those of the coil W5-1 by a slot pitch of 1. In other words, the coil V5-1 is disposed in the slots having slot identification numbers 34 and 36, upon being shaped so that currents flow in opposite directions through the winding disposed in the slot having slot identification number 34 and the winding disposed in the slot having slot identification number 36 shifted from the slot having slot identification number 34 by a coil pitch of 2. The coil W5-2 is disposed in slots shifted from those of the coil S5-1 by a slot pitch of 4. In other words, the coil W5-2 is disposed in the slots having slot identification numbers 37 and 39, upon being shaped so that currents flow in opposite directions through the winding disposed in the slot having slot identification number 37 and the winding disposed in the slot having slot identification number 39 shifted from the slot having slot identification number 37 by a coil pitch of 2. The coil U5-2 is disposed in slots shifted from those of the coil W5-2 by a slot pitch of 1. In other words, the coil U5-2 is disposed in the slots having slot identification numbers 38 and 40, upon being shaped so that currents flow in opposite directions through the winding disposed in the slot having slot identification number 38 and the winding disposed in the slot having slot identification number 40 shifted from the slot having slot identification number 38 by a coil pitch of 2.

In the sixth group of coils, one lap winding set in which two coils V6-1 and U6-1 having the same coil pitch are arranged in slots shifted from each other by a slot pitch of 1 is formed, and another lap winding set in which two coils V6-2 and W6-2 having the same coil pitch are arranged in slots shifted from each other by a slot pitch of 1 is formed to be shifted from the first lap winding set by four slots in the circumferential direction. The sixth group of coils is shifted in position from the fifth group of coils by 60 degrees in the circumferential direction (in the example illustrated in FIG. 16, clockwise). More specifically, the coil V6-1 is disposed in the slots having slot identification numbers 41 and 43, upon being shaped so that currents flow in opposite directions through the winding disposed in the slot having slot identification number 41 and the winding disposed in the slot having slot identification number 43 shifted from the slot having slot identification number 41 by a coil pitch of 2. The coil U6-1 is disposed in slots shifted from those of the coil V6-1 by a slot pitch of 1. In other words, the coil U6-1 is disposed in the slots having slot identification numbers 42 and 44, upon being shaped so that currents flow in opposite directions through the winding disposed in the slot having slot identification number 42 and the winding disposed in the slot having slot identification number 44 shifted from the slot having slot identification number 42 by a coil pitch of 2. The coil V6-2 is disposed in slots shifted from those of the coil V6-1 by a slot pitch of 4. In other words, the coil V6-2 is disposed in the slots having slot identification numbers 45 and 47, upon being shaped so that currents flow in opposite directions through the winding disposed in the slot having slot identification number 45 and the winding disposed in the slot having slot identification number 47 shifted from the slot having slot identification number 45 by a coil pitch of 2. The coil W6-2 is disposed in slots shifted from those of the coil V6-2 by a slot pitch of 1. In other words, the coil W6-2 is disposed in the slots having slot identification numbers 46 and 48, upon being shaped so that currents flow in opposite directions through the winding disposed in the slot having slot identification number 46 and the winding disposed in the slot having slot identification number 48 shifted from the slot having slot identification number 46 by a coil pitch of 2.

The above-mentioned coils U1-1, U1-2, U2-2, U3-1, U4-1, U4-2, U5-2, and U6-1 are connected to each other via a crossover line and serve as U-phase windings in the stator 1. The above-mentioned coils V1-2, V2-1, V2-2, V3-2, V4-2, V5-1, V5-2, and V6-2 are connected to each other via a crossover line and serve as V-phase windings in the stator 1. The above-mentioned coils W1-1, W2-1, W2-2, W3-2, W4-1, W5-1, W5-2, and W6-2 are connected to each other via a crossover line and serve as W-phase windings in the stator 1. The 22-pole, 48-slot three-phase AC motor includes the above-mentioned stator 1, and a rotor facing the stator 1 in the radial direction.

In the 22-pole, 48-slot three-phase AC motor, none of the axes of line symmetry 100U, 100V, and 100W of the respective phases coincide with any lines (100) dividing the first to sixth groups of coils.

A stator in a 22-pole, 72-slot three-phase AC motor will be described below.

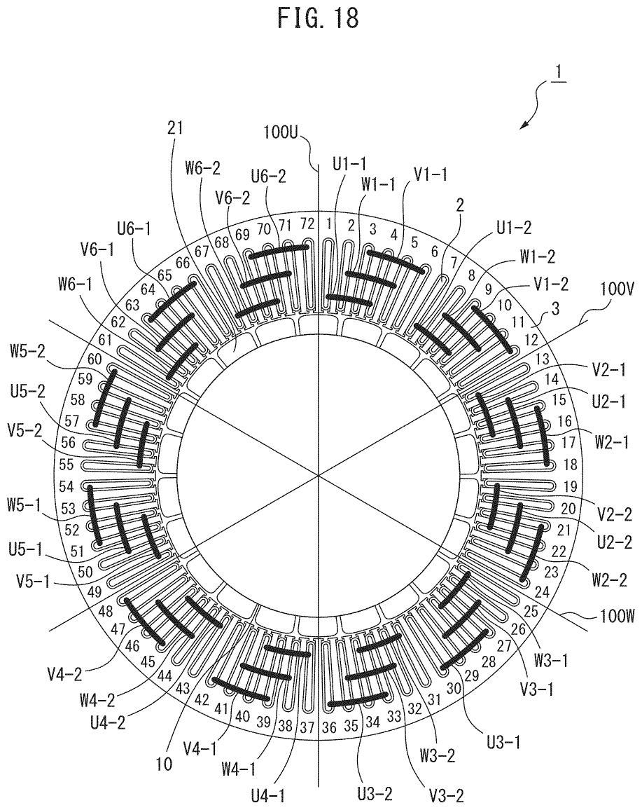

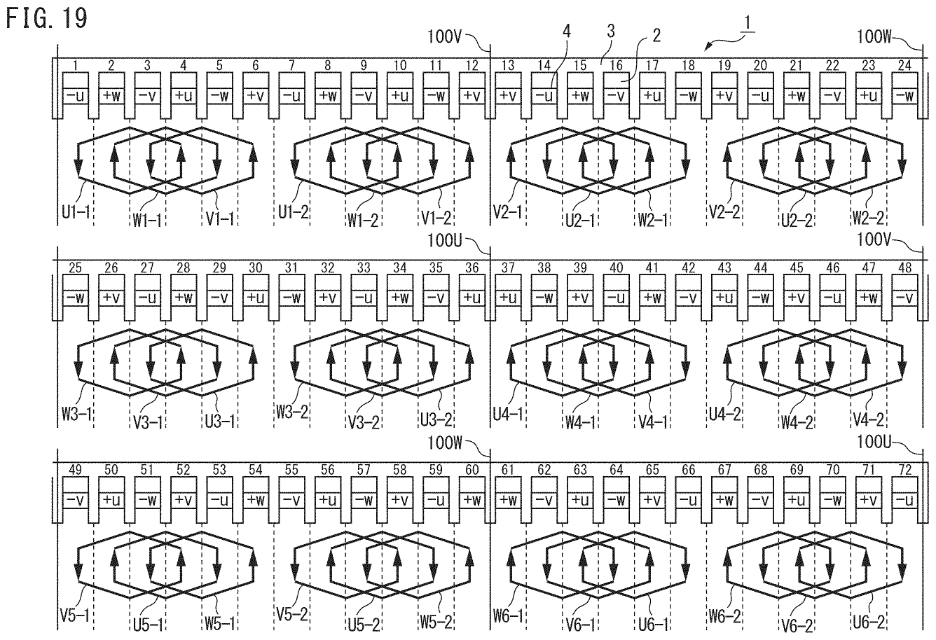

FIG. 18 is a sectional view illustrating a stator in a 22-pole, 72-slot three-phase AC motor according to an embodiment of the present disclosure. FIG. 19 is a developed sectional view of the stator illustrated in FIG. 18.

In, e.g., the 22-pole, 72-slot three-phase AC motor, since the value obtained by dividing the number of slots of 72 by the number of poles of 22 is about 3.3, the motor satisfies the requirement “the number of slots is larger than 1.5 times the number of poles.” In addition, since 36/11 taken as the value obtained by dividing the number of slots of 72 by the number of poles of 22 is an irreducible fraction, the motor can be said to be of the fractional slot type.

The 22-pole, 72-slot three-phase AC motor corresponds to mode (II), in which the coil pitch is 3, and the number of continuous coils is 3. Hence, three coils each having a coil pitch of 3 are arranged in one set to be shifted from each other by a slot pitch of 1 and span six slots. Further, since 12 (=72/6) slots are assigned to each of the first to sixth groups of coils, two sets of coils, each wound by lap winding to occupy six slots, can be arranged for each group of coils.

Therefore, two lap winding sets, each of which is formed by three continuous coils each having a coil pitch of 3 and spans six slots, are disposed, and the two lap winding sets thus span a total of 12 slots. Upon setting these two lap winding sets as one group of coils, such groups of coils are arranged as equally divided into six groups of coils throughout all the 72 slots, thus disposing two separate lap winding sets in each group of coils. The three coils of each lap winding set respectively serve as a U-phase winding defined as a first-phase winding, a V-phase winding defined as a second-phase winding, and a W-phase winding defined as a third-phase winding.

In the first group of coils, one lap winding set in which three coils U1-1, W1-1, and V1-1 having the same coil pitch are arranged in slots shifted from each other by a slot pitch of 1 is formed, and another lap winding set in which three coils U1-2, W1-2, and V1-2 having the same coil pitch are arranged in slots shifted from each other by a slot pitch of 1 is formed to be shifted from the first lap winding set by six slots in the circumferential direction. More specifically, the coil U1-1 is disposed in the slots having slot identification numbers 1 and 4, upon being shaped so that currents flow in opposite directions through the winding disposed in the slot having slot identification number 1 and the winding disposed in the slot having slot identification number 4 shifted from the slot having slot identification number 1 by a coil pitch of 3. The coil W1-1 is disposed in slots shifted from those of the coil U1-1 by a slot pitch of 1. In other words, the coil W1-1 is disposed in the slots having slot identification numbers 2 and 5, upon being shaped so that currents flow in opposite directions through the winding disposed in the slot having slot identification number 2 and the winding disposed in the slot having slot identification number 5 shifted from the slot having slot identification number 2 by a coil pitch of 3. The coil V1-1 is disposed in slots shifted from those of the coil W1-1 by a slot pitch of 1. In other words, the coil V1-1 is disposed in the slots having slot identification numbers 3 and 6, upon being shaped so that currents flow in opposite directions through the winding disposed in the slot having slot identification number 3 and the winding disposed in the slot having slot identification number 6 shifted from the slot having slot identification number 3 by a coil pitch of 3. The coil U1-2 is disposed in slots shifted from those of the coil U1-1 by a slot pitch of 6. In other words, the coil U1-2 is disposed in the slots having slot identification numbers 7 and 10, upon being shaped so that currents flow in opposite directions through the winding disposed in the slot having slot identification number 7 and the winding disposed in the slot having slot identification number 10 shifted from the slot having slot identification number 7 by a coil pitch of 3. The coil W1-2 is disposed in slots shifted from those of the coil U1-2 by a slot pitch of 1. In other words, the coil W1-2 is disposed in the slots having slot identification numbers 8 and 11, upon being shaped so that currents flow in opposite directions through the winding disposed in the slot having slot identification number 8 and the winding disposed in the slot having slot identification number 11 shifted from the slot having slot identification number 8 by a coil pitch of 3. The coil V1-2 is disposed in slots shifted from those of the coil W1-2 by a slot pitch of 1. In other words, the coil V1-2 is disposed in the slots having slot identification numbers 9 and 12, upon being shaped so that currents flow in opposite directions through the winding disposed in the slot having slot identification number 9 and the winding disposed in the slot having slot identification number 12 shifted from the slot having slot identification number 9 by a coil pitch of 3.

In the second group of coils, one lap winding set in which three coils V2-1, U2-1, and W2-1 having the same coil pitch are arranged in slots shifted from each other by a slot pitch of 1 is formed, and another lap winding set in which three coils V2-2, U2-2, and W2-2 having the same coil pitch are arranged in slots shifted from each other by a slot pitch of 1 is formed to be shifted from the first lap winding set by six slots in the circumferential direction. The second group of coils is shifted in position from the first group of coils by 60 degrees in the circumferential direction (in the example illustrated in FIG. 18, clockwise). More specifically, the coil V2-1 is disposed in the slots having slot identification numbers 13 and 16, upon being shaped so that currents flow in opposite directions through the winding disposed in the slot having slot identification number 13 and the winding disposed in the slot having slot identification number 16 shifted from the slot having slot identification number 13 by a coil pitch of 3. The coil U2-1 is disposed in slots shifted from those of the coil V2-1 by a slot pitch of 1. In other words, the coil U2-1 is disposed in the slots having slot identification numbers 14 and 17, upon being shaped so that currents flow in opposite directions through the winding disposed in the slot having slot identification number 14 and the winding disposed in the slot having slot identification number 17 shifted from the slot having slot identification number 14 by a coil pitch of 3. The coil W2-1 is disposed in slots shifted from those of the coil U2-1 by a slot pitch of 1. In other words, the coil W2-1 is disposed in the slots having slot identification numbers 15 and 18, upon being shaped so that currents flow in opposite directions through the winding disposed in the slot having slot identification number 15 and the winding disposed in the slot having slot identification number 18 shifted from the slot having slot identification number 15 by a coil pitch of 3. The coil V2-2 is disposed in slots shifted from those of the coil V2-1 by a slot pitch of 6. In other words, the coil V2-2 is disposed in the slots having slot identification numbers 19 and 22, upon being shaped so that currents flow in opposite directions through the winding disposed in the slot having slot identification number 19 and the winding disposed in the slot having slot identification number 22 shifted from the slot having slot identification number 19 by a coil pitch of 3. The coil U2-2 is disposed in slots shifted from those of the coil V2-2 by a slot pitch of 1. In other words, the coil U2-2 is disposed in the slots having slot identification numbers 20 and 23, upon being shaped so that currents flow in opposite directions through the winding disposed in the slot having slot identification number 20 and the winding disposed in the slot having slot identification number 23 shifted from the slot having slot identification number 20 by a coil pitch of 3. The coil W2-2 is disposed in slots shifted from those of the coil U2-2 by a slot pitch of 1. In other words, the coil W2-2 is disposed in the slots having slot identification numbers 21 and 24, upon being shaped so that currents flow in opposite directions through the winding disposed in the slot having slot identification number 21 and the winding disposed in the slot having slot identification number 24 shifted from the slot having slot identification number 21 by a coil pitch of 3.

In the third group of coils, one lap winding set in which three coils W3-1, V3-1, and U3-1 having the same coil pitch are arranged in slots shifted from each other by a slot pitch of 1 is formed, and another lap winding set in which three coils W3-2, V3-2, and U3-2 having the same coil pitch are arranged in slots shifted from each other by a slot pitch of 1 is formed to be shifted from the first lap winding set by six slots in the circumferential direction. The third group of coils is shifted in position from the second group of coils by 60 degrees in the circumferential direction (in the example illustrated in FIG. 18, clockwise). More specifically, the coil W3-1 is disposed in the slots having slot identification numbers 25 and 28, upon being shaped so that currents flow in opposite directions through the winding disposed in the slot having slot identification number 25 and the winding disposed in the slot having slot identification number 28 shifted from the slot having slot identification number 25 by a coil pitch of 3. The coil V3-1 is disposed in slots shifted from those of the coil W3-1 by a slot pitch of 1. In other words, the coil V3-1 is disposed in the slots having slot identification numbers 26 and 29, upon being shaped so that currents flow in opposite directions through the winding disposed in the slot having slot identification number 26 and the winding disposed in the slot having slot identification number 29 shifted from the slot having slot identification number 26 by a coil pitch of 3. The coil U3-1 is disposed in slots shifted from those of the coil V3-1 by a slot pitch of 1. In other words, the coil U3-1 is disposed in the slots having slot identification numbers 27 and 30, upon being shaped so that currents flow in opposite directions through the winding disposed in the slot having slot identification number 27 and the winding disposed in the slot having slot identification number 30 shifted from the slot having slot identification number 27 by a coil pitch of 3. The coil W3-2 is disposed in slots shifted from those of the coil W3-1 by a slot pitch of 6. In other words, the coil W3-2 is disposed in the slots having slot identification numbers 31 and 34, upon being shaped so that currents flow in opposite directions through the winding disposed in the slot having slot identification number 31 and the winding disposed in the slot having slot identification number 34 shifted from the slot having slot identification number 31 by a coil pitch of 3. The coil V3-2 is disposed in slots shifted from those of the coil W3-2 by a slot pitch of 1. In other words, the coil V3-2 is disposed in the slots having slot identification numbers 32 and 35, upon being shaped so that currents flow in opposite directions through the winding disposed in the slot having slot identification number 32 and the winding disposed in the slot having slot identification number 35 shifted from the slot having slot identification number 32 by a coil pitch of 3. The coil U3-2 is disposed in slots shifted from those of the coil V3-2 by a slot pitch of 1. In other words, the coil U3-2 is disposed in the slots having slot identification numbers 33 and 36, upon being shaped so that currents flow in opposite directions through the winding disposed in the slot having slot identification number 33 and the winding disposed in the slot having slot identification number 36 shifted from the slot having slot identification number 33 by a coil pitch of 3.

In the fourth group of coils, one lap winding set in which three coils U4-1, W4-1, and V4-1 having the same coil pitch are arranged in slots shifted from each other by a slot pitch of 1 is formed, and another lap winding set in which three coils U4-2, W4-2, and V4-2 having the same coil pitch are arranged in slots shifted from each other by a slot pitch of 1 is formed to be shifted from the first lap winding set by six slots in the circumferential direction. The fourth group of coils is shifted in position from the third group of coils by 60 degrees in the circumferential direction (in the example illustrated in FIG. 18, clockwise). More specifically, the coil U4-1 is disposed in the slots having slot identification numbers 37 and 40, upon being shaped so that currents flow in opposite directions through the winding disposed in the slot having slot identification number 37 and the winding disposed in the slot having slot identification number 40 shifted from the slot having slot identification number 37 by a coil pitch of 3. The coil W4-1 is disposed in slots shifted from those of the coil U4-1 by a slot pitch of 1. In other words, the coil W4-1 is disposed in the slots having slot identification numbers 38 and 41, upon being shaped so that currents flow in opposite directions through the winding disposed in the slot having slot identification number 38 and the winding disposed in the slot having slot identification number 41 shifted from the slot having slot identification number 38 by a coil pitch of 3. The coil V4-1 is disposed in slots shifted from those of the coil W4-1 by a slot pitch of 1. In other words, the coil V4-1 is disposed in the slots having slot identification numbers 39 and 42, upon being shaped so that currents flow in opposite directions through the winding disposed in the slot having slot identification number 39 and the winding disposed in the slot having slot identification number 42 shifted from the slot having slot identification number 39 by a coil pitch of 3. The coil U4-2 is disposed in slots shifted from those of the coil U4-1 by a slot pitch of 6. In other words, the coil U4-2 is disposed in the slots having slot identification numbers 43 and 46, upon being shaped so that currents flow in opposite directions through the winding disposed in the slot having slot identification number 43 and the winding disposed in the slot having slot identification number 46 shifted from the slot having slot identification number 43 by a coil pitch of 3. The coil W4-2 is disposed in slots shifted from those of the coil U4-2 by a slot pitch of 1. In other words, the coil W4-2 is disposed in the slots having slot identification numbers 44 and 47, upon being shaped so that currents flow in opposite directions through the winding disposed in the slot having slot identification number 44 and the winding disposed in the slot having slot identification number 47 shifted from the slot having slot identification number 44 by a coil pitch of 3. The coil V4-2 is disposed in slots shifted from those of the coil W4-2 by a slot pitch of 1. In other words, the coil V4-2 is disposed in the slots having slot identification numbers 45 and 48, upon being shaped so that currents flow in opposite directions through the winding disposed in the slot having slot identification number 45 and the winding disposed in the slot having slot identification number 48 shifted from the slot having slot identification number 45 by a coil pitch of 3.

In the fifth group of coils, one lap winding set in which three coils V5-1, U5-1, and W5-1 having the same coil pitch are arranged in slots shifted from each other by a slot pitch of 1 is formed, and another lap winding set in which three coils V5-2, U5-2, and W5-2 having the same coil pitch are arranged in slots shifted from each other by a slot pitch of 1 is formed to be shifted from the first lap winding set by six slots in the circumferential direction. The fifth group of coils is shifted in position from the fourth group of coils by 60 degrees in the circumferential direction (in the example illustrated in FIG. 18, clockwise). More specifically, the coil V5-1 is disposed in the slots having slot identification numbers 49 and 52, upon being shaped so that currents flow in opposite directions through the winding disposed in the slot having slot identification number 49 and the winding disposed in the slot having slot identification number 52 shifted from the slot having slot identification number 49 by a coil pitch of 3. The coil U5-1 is disposed in slots shifted from those of the coil V5-1 by a slot pitch of 1. In other words, the coil U5-1 is disposed in the slots having slot identification numbers 50 and 53, upon being shaped so that currents flow in opposite directions through the winding disposed in the slot having slot identification number 50 and the winding disposed in the slot having slot identification number 53 shifted from the slot having slot identification number 50 by a coil pitch of 3. The coil W5-1 is disposed in slots shifted from those of the coil U5-1 by a slot pitch of 1. In other words, the coil W5-1 is disposed in the slots having slot identification numbers 51 and 54, upon being shaped so that currents flow in opposite directions through the winding disposed in the slot having slot identification number 51 and the winding disposed in the slot having slot identification number 54 shifted from the slot having slot identification number 51 by a coil pitch of 3. The coil V5-2 is disposed in slots shifted from those of the coil V5-1 by a slot pitch of 6. In other words, the coil V5-2 is disposed in the slots having slot identification numbers 55 and 58, upon being shaped so that currents flow in opposite directions through the winding disposed in the slot having slot identification number 55 and the winding disposed in the slot having slot identification number 58 shifted from the slot having slot identification number 55 by a coil pitch of 3. The coil U5-2 is disposed in slots shifted from those of the coil V5-2 by a slot pitch of 1. In other words, the coil U5-2 is disposed in the slots having slot identification numbers 56 and 59, upon being shaped so that currents flow in opposite directions through the winding disposed in the slot having slot identification number 56 and the winding disposed in the slot having slot identification number 59 shifted from the slot having slot identification number 56 by a coil pitch of 3. The coil W5-2 is disposed in slots shifted from those of the coil U5-2 by a slot pitch of 1. In other words, the coil W5-2 is disposed in the slots having slot identification numbers 57 and 60, upon being shaped so that currents flow in opposite directions through the winding disposed in the slot having slot identification number 57 and the winding disposed in the slot having slot identification number 60 shifted from the slot having slot identification number 57 by a coil pitch of 3.

In the sixth group of coils, one lap winding set in which three coils W6-1, V6-1, and U6-1 having the same coil pitch are arranged in slots shifted from each other by a slot pitch of 1 is formed, and another lap winding set in which three coils W6-2, V6-2, and U6-2 having the same coil pitch are arranged in slots shifted from each other by a slot pitch of 1 is formed to be shifted from the first lap winding set by six slots in the circumferential direction. The sixth group of coils is shifted in position from the fifth group of coils by 60 degrees in the circumferential direction (in the example illustrated in FIG. 18, clockwise). More specifically, the coil W6-1 is disposed in the slots having slot identification numbers 61 and 64, upon being shaped so that currents flow in opposite directions through the winding disposed in the slot having slot identification number 61 and the winding disposed in the slot having slot identification number 64 shifted from the slot having slot identification number 61 by a coil pitch of 3. The coil V6-1 is disposed in slots shifted from those of the coil W6-1 by a slot pitch of 1. In other words, the coil V6-1 is disposed in the slots having slot identification numbers 62 and 65, upon being shaped so that currents flow in opposite directions through the winding disposed in the slot having slot identification number 62 and the winding disposed in the slot having slot identification number 65 shifted from the slot having slot identification number 62 by a coil pitch of 3. The coil U6-1 is disposed in slots shifted from those of the coil V6-1 by a slot pitch of 1. In other words, the coil U6-1 is disposed in the slots having slot identification numbers 63 and 66, upon being shaped so that currents flow in opposite directions through the winding disposed in the slot having slot identification number 63 and the winding disposed in the slot having slot identification number 66 shifted from the slot having slot identification number 63 by a coil pitch of 3. The coil W6-2 is disposed in slots shifted from those of the coil W6-1 by a slot pitch of 6. In other words, the coil W6-2 is disposed in the slots having slot identification numbers 67 and 70, upon being shaped so that currents flow in opposite directions through the winding disposed in the slot having slot identification number 67 and the winding disposed in the slot having slot identification number 70 shifted from the slot having slot identification number 67 by a coil pitch of 3. The coil V6-2 is disposed in slots shifted from those of the coil W6-2 by a slot pitch of 1. In other words, the coil V6-2 is disposed in the slots having slot identification numbers 68 and 71, upon being shaped so that currents flow in opposite directions through the winding disposed in the slot having slot identification number 68 and the winding disposed in the slot having slot identification number 71 shifted from the slot having slot identification number 68 by a coil pitch of 3. The coil U6-2 is disposed in slots shifted from those of the coil V6-2 by a slot pitch of 1. In other words, the coil U6-2 is disposed in the slots having slot identification numbers 69 and 72, upon being shaped so that currents flow in opposite directions through the winding disposed in the slot having slot identification number 69 and the winding disposed in the slot having slot identification number 72 shifted from the slot having slot identification number 69 by a coil pitch of 3.

The above-mentioned coils U1-1, U1-2, U2-1, U2-2, U3-1, U3-2, U4-1, U4-2, U5-1, U5-2, U6-1, and U6-2 are connected to each other via a crossover line and serve as U-phase windings in the stator 1. The above-mentioned coils V1-1, V1-2, V2-1, V2-2, V3-1, V3-2, V4-1, V4-2, V5-1, V5-2, V6-1, and V6-2 are connected to each other via a crossover line and serve as V-phase windings in the stator 1. The above-mentioned coils W1-1, W1-2, W2-1, W2-2, W3-1, W3-2, W4-1, W4-2, W5-1, W5-2, W6-1, and W6-2 are connected to each other via a crossover line and serve as W-phase windings in the stator 1. The 22-pole, 72-slot three-phase AC motor includes the above-mentioned stator 1, and a rotor facing the stator 1 in the radial direction.

In the 22-pole, 72-slot three-phase AC motor, the axes of line symmetry 100U, 100V, and 100W of the respective phases coincide with lines dividing the first to sixth groups of coils.

A stator in a 34-pole, 108-slot three-phase AC motor will be described below.

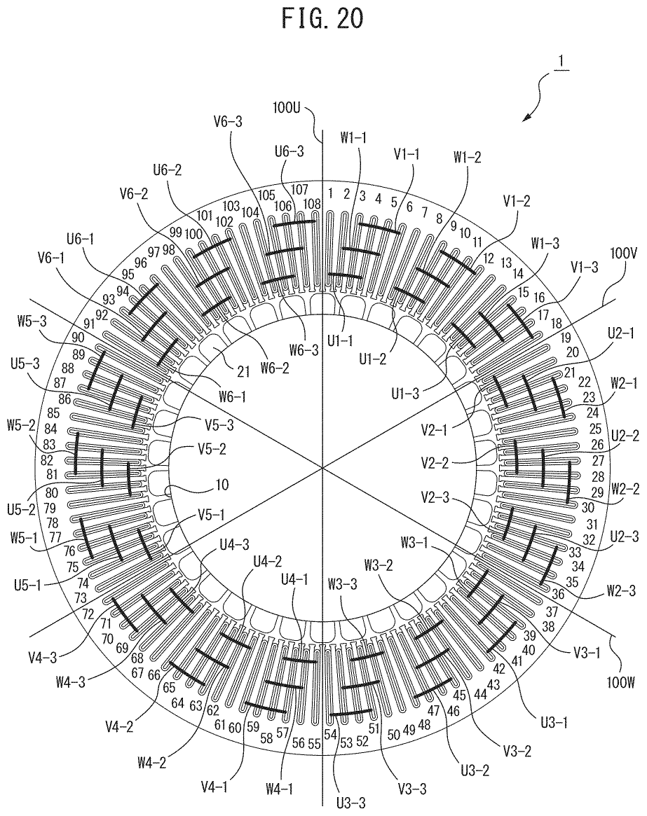

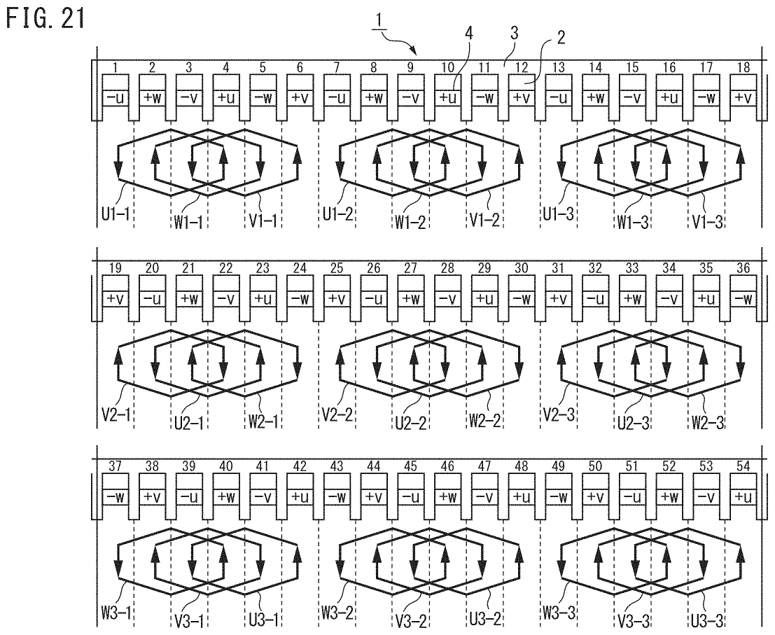

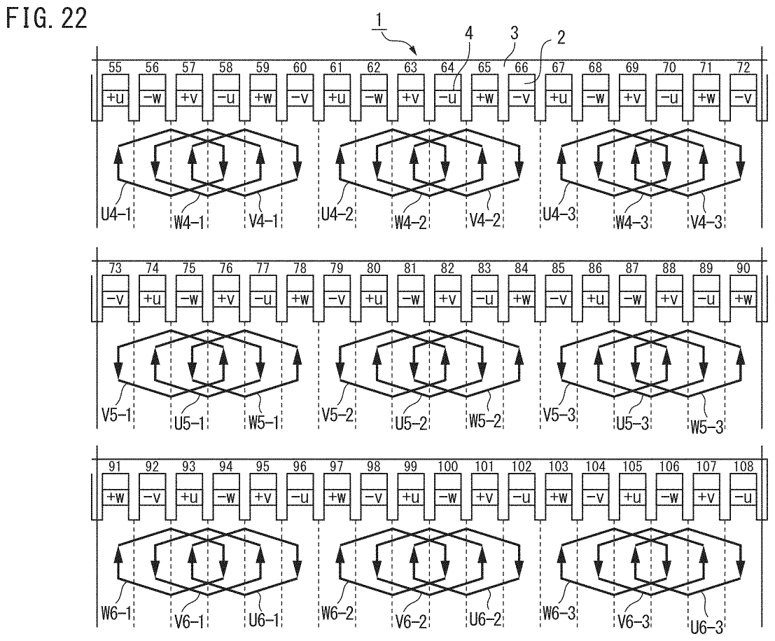

FIG. 20 is a sectional view illustrating a stator in a 34-pole, 108-slot three-phase AC motor according to an embodiment of the present disclosure. FIG. 21 is a developed sectional view of the stator illustrated in FIG. 20 for slot identification numbers 1 to 54. FIG. 22 is a developed sectional view of the stator illustrated in FIG. 20 for slot identification numbers 55 to 108.

In, e.g., the 34-pole, 108-slot three-phase AC motor, since the value obtained by dividing the number of slots of 108 by the number of poles of 34 is about 3.2, the motor satisfies the requirement “the number of slots is larger than 1.5 times the number of poles.” In addition, since 54/17 taken as the value obtained by dividing the number of slots of 108 by the number of poles of 34 is an irreducible fraction, the motor can be said to be of the fractional slot type.

The 34-pole, 108-slot three-phase AC motor corresponds to mode (II), in which the coil pitch is 3, and the number of continuous coils is 3. Hence, three coils each having a coil pitch of 3 are arranged in one lap winding set to be shifted from each other by a slot pitch of 1 and span six slots. Further, since 18 (=108/6) slots are assigned to each of the first to sixth groups of coils, three sets of coils, each wound by lap winding to occupy six slots, can be arranged for each group of coils. Therefore, three sets of coils, each of which is wound by lap winding of three continuous coils each having a coil pitch of 3 and spans six slots, are disposed, and three lap winding sets thus span a total of 18 slots. Upon setting these three lap winding sets as one group of coils, such groups of coils are arranged as equally divided into six groups of coils throughout all the 108 slots, thus allowing separate lap winding in each group of coils. The three coils of each lap winding set respectively serve as a U-phase winding defined as a first-phase winding, a V-phase winding defined as a second-phase winding, and a W-phase winding defined as a third-phase winding.

The first group of coils is disposed in the slots having slot identification numbers 1 to 18. The second group of coils is disposed in the slots having slot identification numbers 19 to 36, i.e., at a position shifted from the first group of coils by 60 degrees in the circumferential direction (in the example illustrated in FIG. 20, clockwise). The third group of coils is disposed in the slots having slot identification numbers 37 to 54, i.e., at a position shifted from the second group of coils by 60 degrees in the circumferential direction (in the example illustrated in FIG. 20, clockwise). The fourth group of coils is disposed in the slots having slot identification numbers 55 to 72, i.e., at a position shifted from the third group of coils by 60 degrees in the circumferential direction (in the example illustrated in FIG. 20, clockwise). The fifth group of coils is disposed in the slots having slot identification numbers 73 to 90, i.e., at a position shifted from the fourth group of coils by 60 degrees in the circumferential direction (in the example illustrated in FIG. 20, clockwise). The sixth group of coils is disposed in the slots having slot identification numbers 91 to 108, i.e., at a position shifted from the fifth group of coils by 60 degrees in the circumferential direction (in the example illustrated in FIG. 20, clockwise).

In the first group of coils, one lap winding set in which three coils U1-1, W1-1, and V1-1 having the same coil pitch are arranged in slots shifted from each other by a slot pitch of 1 is formed, another lap winding set in which three coils U1-2, W1-2, and V1-2 having the same coil pitch are arranged in slots shifted from each other by a slot pitch of 1 is formed to be shifted from the first lap winding set by six slots in the circumferential direction, and still another lap winding set in which three coils U1-3, W1-3, and V1-3 having the same coil pitch are arranged in slots shifted from each other by a slot pitch of 1 is formed to be shifted from the second lap winding set by six slots in the circumferential direction. More specifically, the coil U1-1 is disposed in the slots having slot identification numbers 1 and 4, upon being shaped so that currents flow in opposite directions through the winding disposed in the slot having slot identification number 1 and the winding disposed in the slot having slot identification number 4 shifted from the slot having slot identification number 1 by a coil pitch of 3. The coil W1-1 is disposed in slots shifted from those of the coil U1-1 by a slot pitch of 1. In other words, the coil W1-1 is disposed in the slots having slot identification numbers 2 and 5, upon being shaped so that currents flow in opposite directions through the winding disposed in the slot having slot identification number 2 and the winding disposed in the slot having slot identification number 5 shifted from the slot having slot identification number 2 by a coil pitch of 3. The coil V1-1 is disposed in slots shifted from those of the coil W1-1 by a slot pitch of 1. In other words, the coil V1-1 is disposed in the slots having slot identification numbers 3 and 6, upon being shaped so that currents flow in opposite directions through the winding disposed in the slot having slot identification number 3 and the winding disposed in the slot having slot identification number 6 shifted from the slot having slot identification number 3 by a coil pitch of 3. The coil U1-2 is disposed in slots shifted from those of the coil U1-1 by a slot pitch of 6. In other words, the coil U1-2 is disposed in the slots having slot identification numbers 7 and 10, upon being shaped so that currents flow in opposite directions through the winding disposed in the slot having slot identification number 7 and the winding disposed in the slot having slot identification number 10 shifted from the slot having slot identification number 7 by a coil pitch of 3. The coil W1-2 is disposed in slots shifted from those of the coil U1-2 by a slot pitch of 1. In other words, the coil W1-2 is disposed in the slots having slot identification numbers 8 and 11, upon being shaped so that currents flow in opposite directions through the winding disposed in the slot having slot identification number 8 and the winding disposed in the slot having slot identification number 11 shifted from the slot having slot identification number 8 by a coil pitch of 3. The coil V1-2 is disposed in slots shifted from those of the coil W1-2 by a slot pitch of 1. In other words, the coil V1-2 is disposed in the slots having slot identification numbers 9 and 12, upon being shaped so that currents flow in opposite directions through the winding disposed in the slot having slot identification number 9 and the winding disposed in the slot having slot identification number 12 shifted from the slot having slot identification number 9 by a coil pitch of 3. The coil U1-3 is disposed in slots shifted from those of the coil U1-2 by a slot pitch of 6. In other words, the coil U1-3 is disposed in the slots having slot identification numbers 13 and 16, upon being shaped so that currents flow in opposite directions through the winding disposed in the slot having slot identification number 13 and the winding disposed in the slot having slot identification number 16 shifted from the slot having slot identification number 13 by a coil pitch of 3. The coil W1-3 is disposed in slots shifted from those of the coil U1-3 by a slot pitch of 1. In other words, the coil W1-2 is disposed in the slots having slot identification numbers 14 and 17, upon being shaped so that currents flow in opposite directions through the winding disposed in the slot having slot identification number 14 and the winding disposed in the slot having slot identification number 17 shifted from the slot having slot identification number 14 by a coil pitch of 3. The coil V1-3 is disposed in slots shifted from those of the coil W1-3 by a slot pitch of 1. In other words, the coil V1-3 is disposed in the slots having slot identification numbers 15 and 18, upon being shaped so that currents flow in opposite directions through the winding disposed in the slot having slot identification number 15 and the winding disposed in the slot having slot identification number 18 shifted from the slot having slot identification number 15 by a coil pitch of 3.

In the second group of coils, one lap winding set in which three coils V2-1, U2-1, and W2-1 having the same coil pitch are arranged in slots shifted from each other by a slot pitch of 1 is formed, another lap winding set in which three coils V2-2, U2-2, and W2-2 having the same coil pitch are arranged in slots shifted from each other by a slot pitch of 1 is formed to be shifted from the first lap winding set by six slots in the circumferential direction, and still another lap winding set in which three coils V2-3, U2-3, and W2-3 having the same coil pitch are arranged in slots shifted from each other by a slot pitch of 1 is formed to be shifted from the second lap winding set by six slots in the circumferential direction. The third group of coils is shifted in position from the second group of coils by 60 degrees in the circumferential direction (in the example illustrated in FIG. 20, clockwise). More specifically, the coil V2-1 is disposed in the slots having slot identification numbers 19 and 22, upon being shaped so that currents flow in opposite directions through the winding disposed in the slot having slot identification number 19 and the winding disposed in the slot having slot identification number 22 shifted from the slot having slot identification number 19 by a coil pitch of 3. The coil U2-1 is disposed in slots shifted from those of the coil V2-1 by a slot pitch of 1. In other words, the coil U2-1 is disposed in the slots having slot identification numbers 20 and 23, upon being shaped so that currents flow in opposite directions through the winding disposed in the slot having slot identification number 20 and the winding disposed in the slot having slot identification number 23 shifted from the slot having slot identification number 20 by a coil pitch of 3. The coil W2-1 is disposed in slots shifted from those of the coil U2-1 by a slot pitch of 1. In other words, the coil W2-1 is disposed in the slots having slot identification numbers 21 and 24, upon being shaped so that currents flow in opposite directions through the winding disposed in the slot having slot identification number 21 and the winding disposed in the slot having slot identification number 24 shifted from the slot having slot identification number 21 by a coil pitch of 3. The coil V2-2 is disposed in slots shifted from those of the coil V2-1 by a slot pitch of 6. In other words, the coil V2-2 is disposed in the slots having slot identification numbers 25 and 28, upon being shaped so that currents flow in opposite directions through the winding disposed in the slot having slot identification number 25 and the winding disposed in the slot having slot identification number 28 shifted from the slot having slot identification number 25 by a coil pitch of 3. The coil U2-2 is disposed in slots shifted from those of the coil V2-2 by a slot pitch of 1. In other words, the coil U2-2 is disposed in the slots having slot identification numbers 26 and 29, upon being shaped so that currents flow in opposite directions through the winding disposed in the slot having slot identification number 26 and the winding disposed in the slot having slot identification number 29 shifted from the slot having slot identification number 26 by a coil pitch of 3. The coil W2-2 is disposed in slots shifted from those of the coil U2-2 by a slot pitch of 1. In other words, the coil W2-2 is disposed in the slots having slot identification numbers 21 and 24, upon being shaped so that currents flow in opposite directions through the winding disposed in the slot having slot identification number 27 and the winding disposed in the slot having slot identification number 30 shifted from the slot having slot identification number 27 by a coil pitch of 3. The coil V2-3 is disposed in slots shifted from those of the coil V2-2 by a slot pitch of 6. In other words, the coil V2-3 is disposed in the slots having slot identification numbers 31 and 34, upon being shaped so that currents flow in opposite directions through the winding disposed in the slot having slot identification number 31 and the winding disposed in the slot having slot identification number 34 shifted from the slot having slot identification number 31 by a coil pitch of 3. The coil U2-3 is disposed in slots shifted from those of the coil V2-3 by a slot pitch of 1. In other words, the coil U2-3 is disposed in the slots having slot identification numbers 32 and 35, upon being shaped so that currents flow in opposite directions through the winding disposed in the slot having slot identification number 32 and the winding disposed in the slot having slot identification number 35 shifted from the slot having slot identification number 32 by a coil pitch of 3. The coil W2-3 is disposed in slots shifted from those of the coil U2-3 by a slot pitch of 1. In other words, the coil W2-3 is disposed in the slots having slot identification numbers 33 and 36, upon being shaped so that currents flow in opposite directions through the winding disposed in the slot having slot identification number 33 and the winding disposed in the slot having slot identification number 36 shifted from the slot having slot identification number 33 by a coil pitch of 3.

In the third group of coils, one lap winding set in which three coils W3-1, V3-1, and U3-1 having the same coil pitch are arranged in slots shifted from each other by a slot pitch of 1 is formed, another lap winding set in which three coils W3-2, V3-2, and U3-2 having the same coil pitch are arranged in slots shifted from each other by a slot pitch of 1 is formed to be shifted from the first lap winding set by six slots in the circumferential direction, and still another lap winding set in which three coils W3-3, V3-3, and U3-3 having the same coil pitch are arranged in slots shifted from each other by a slot pitch of 1 is formed to be shifted from the second lap winding set by six slots in the circumferential direction. The third group of coils is shifted in position from the second group of coils by 60 degrees in the circumferential direction (in the example illustrated in FIG. 20, clockwise). More specifically, the coil W3-1 is disposed in the slots having slot identification numbers 37 and 40, upon being shaped so that currents flow in opposite directions through the winding disposed in the slot having slot identification number 37 and the winding disposed in the slot having slot identification number 40 shifted from the slot having slot identification number 37 by a coil pitch of 3. The coil V3-1 is disposed in slots shifted from those of the coil W3-1 by a slot pitch of 1. In other words, the coil V3-1 is disposed in the slots having slot identification numbers 38 and 41, upon being shaped so that currents flow in opposite directions through the winding disposed in the slot having slot identification number 38 and the winding disposed in the slot having slot identification number 41 shifted from the slot having slot identification number 38 by a coil pitch of 3. The coil U3-1 is disposed in slots shifted from those of the coil V3-1 by a slot pitch of 1. In other words, the coil U3-1 is disposed in the slots having slot identification numbers 39 and 42, upon being shaped so that currents flow in opposite directions through the winding disposed in the slot having slot identification number 39 and the winding disposed in the slot having slot identification number 42 shifted from the slot having slot identification number 39 by a coil pitch of 3. The coil W3-2 is disposed in slots shifted from those of the coil W3-1 by a slot pitch of 6. In other words, the coil W3-2 is disposed in the slots having slot identification numbers 43 and 46, upon being shaped so that currents flow in opposite directions through the winding disposed in the slot having slot identification number 43 and the winding disposed in the slot having slot identification number 46 shifted from the slot having slot identification number 43 by a coil pitch of 3. The coil V3-2 is disposed in slots shifted from those of the coil W3-2 by a slot pitch of 1. In other words, the coil V3-2 is disposed in the slots having slot identification numbers 44 and 47, upon being shaped so that currents flow in opposite directions through the winding disposed in the slot having slot identification number 44 and the winding disposed in the slot having slot identification number 47 shifted from the slot having slot identification number 44 by a coil pitch of 3. The coil U3-2 is disposed in slots shifted from those of the coil V3-2 by a slot pitch of 1. In other words, the coil U3-2 is disposed in the slots having slot identification numbers 45 and 48, upon being shaped so that currents flow in opposite directions through the winding disposed in the slot having slot identification number 45 and the winding disposed in the slot having slot identification number 48 shifted from the slot having slot identification number 45 by a coil pitch of 3. The coil W3-3 is disposed in slots shifted from those of the coil W3-2 by a slot pitch of 6. In other words, the coil W3-3 is disposed in the slots having slot identification numbers 49 and 52, upon being shaped so that currents flow in opposite directions through the winding disposed in the slot having slot identification number 49 and the winding disposed in the slot having slot identification number 52 shifted from the slot having slot identification number 49 by a coil pitch of 3. The coil V3-3 is disposed in slots shifted from those of the coil W3-3 by a slot pitch of 1. In other words, the coil V3-3 is disposed in the slots having slot identification numbers 50 and 53, upon being shaped so that currents flow in opposite directions through the winding disposed in the slot having slot identification number 50 and the winding disposed in the slot having slot identification number 53 shifted from the slot having slot identification number 50 by a coil pitch of 3. The coil U3-3 is disposed in slots shifted from those of the coil V3-3 by a slot pitch of 1. In other words, the coil U3-3 is disposed in the slots having slot identification numbers 51 and 54, upon being shaped so that currents flow in opposite directions through the winding disposed in the slot having slot identification number 51 and the winding disposed in the slot having slot identification number 54 shifted from the slot having slot identification number 51 by a coil pitch of 3.

In the fourth group of coils, one lap winding set in which three coils U4-1, W4-1, and V4-1 having the same coil pitch are arranged in slots shifted from each other by a slot pitch of 1 is formed, another lap winding set in which three coils U4-2, W4-2, and V4-2 having the same coil pitch are arranged in slots shifted from each other by a slot pitch of 1 is formed to be shifted from the first lap winding set by six slots in the circumferential direction, and still another lap winding set in which three coils U4-3, W4-3, and V4-3 having the same coil pitch are arranged in slots shifted from each other by a slot pitch of 1 is formed to be shifted from the second lap winding set by six slots in the circumferential direction. The fourth group of coils is shifted in position from the third group of coils by 60 degrees in the circumferential direction (in the example illustrated in FIG. 20, clockwise). More specifically, the coil U4-1 is disposed in the slots having slot identification numbers 55 and 58, upon being shaped so that currents flow in opposite directions through the winding disposed in the slot having slot identification number 55 and the winding disposed in the slot having slot identification number 58 shifted from the slot having slot identification number 55 by a coil pitch of 3. The coil W4-1 is disposed in slots shifted from those of the coil U4-1 by a slot pitch of 1. In other words, the coil W4-1 is disposed in the slots having slot identification numbers 56 and 59, upon being shaped so that currents flow in opposite directions through the winding disposed in the slot having slot identification number 56 and the winding disposed in the slot having slot identification number 59 shifted from the slot having slot identification number 56 by a coil pitch of 3. The coil V4-1 is disposed in slots shifted from those of the coil W4-1 by a slot pitch of 1. In other words, the coil V4-1 is disposed in the slots having slot identification numbers 57 and 60, upon being shaped so that currents flow in opposite directions through the winding disposed in the slot having slot identification number 57 and the winding disposed in the slot having slot identification number 60 shifted from the slot having slot identification number 57 by a coil pitch of 3. The coil U4-2 is disposed in slots shifted from those of the coil U4-1 by a slot pitch of 6. In other words, the coil U4-2 is disposed in the slots having slot identification numbers 61 and 64, upon being shaped so that currents flow in opposite directions through the winding disposed in the slot having slot identification number 61 and the winding disposed in the slot having slot identification number 64 shifted from the slot having slot identification number 61 by a coil pitch of 3. The coil W4-2 is disposed in slots shifted from those of the coil U4-2 by a slot pitch of 1. In other words, the coil W4-2 is disposed in the slots having slot identification numbers 62 and 65, upon being shaped so that currents flow in opposite directions through the winding disposed in the slot having slot identification number 62 and the winding disposed in the slot having slot identification number 65 shifted from the slot having slot identification number 62 by a coil pitch of 3. The coil V4-2 is disposed in slots shifted from those of the coil W4-2 by a slot pitch of 1. In other words, the coil V4-2 is disposed in the slots having slot identification numbers 63 and 66, upon being shaped so that currents flow in opposite directions through the winding disposed in the slot having slot identification number 63 and the winding disposed in the slot having slot identification number 66 shifted from the slot having slot identification number 63 by a coil pitch of 3. The coil U4-3 is disposed in slots shifted from those of the coil U4-2 by a slot pitch of 6. In other words, the coil U4-3 is disposed in the slots having slot identification numbers 67 and 70, upon being shaped so that currents flow in opposite directions through the winding disposed in the slot having slot identification number 67 and the winding disposed in the slot having slot identification number 70 shifted from the slot having slot identification number 67 by a coil pitch of 3. The coil W4-3 is disposed in slots shifted from those of the coil U4-3 by a slot pitch of 1. In other words, the coil W4-3 is disposed in the slots having slot identification numbers 68 and 71, upon being shaped so that currents flow in opposite directions through the winding disposed in the slot having slot identification number 68 and the winding disposed in the slot having slot identification number 71 shifted from the slot having slot identification number 68 by a coil pitch of 3. The coil V4-3 is disposed in slots shifted from those of the coil W4-3 by a slot pitch of 1. In other words, the coil V4-3 is disposed in the slots having slot identification numbers 69 and 72, upon being shaped so that currents flow in opposite directions through the winding disposed in the slot having slot identification number 69 and the winding disposed in the slot having slot identification number 72 shifted from the slot having slot identification number 69 by a coil pitch of 3.

In the fifth group of coils, one lap winding set in which three coils V5-1, U5-1, and W5-1 having the same coil pitch are arranged in slots shifted from each other by a slot pitch of 1 is formed, another lap winding set in which three coils V5-2, U5-2, and W5-2 having the same coil pitch are arranged in slots shifted from each other by a slot pitch of 1 is formed to be shifted from the first lap winding set by six slots in the circumferential direction, and still another lap winding set in which three coils V5-3, U5-3, and W5-3 having the same coil pitch are arranged in slots shifted from each other by a slot pitch of 1 is formed to be shifted from the second lap winding set by six slots in the circumferential direction. The fifth group of coils is shifted in position from the fourth group of coils by 60 degrees in the circumferential direction (in the example illustrated in FIG. 20, clockwise). More specifically, the coil V5-1 is disposed in the slots having slot identification numbers 73 and 76, upon being shaped so that currents flow in opposite directions through the winding disposed in the slot having slot identification number 73 and the winding disposed in the slot having slot identification number 76 shifted from the slot having slot identification number 73 by a coil pitch of 3. The coil U5-1 is disposed in slots shifted from those of the coil V5-1 by a slot pitch of 1. In other words, the coil U5-1 is disposed in the slots having slot identification numbers 74 and 77, upon being shaped so that currents flow in opposite directions through the winding disposed in the slot having slot identification number 74 and the winding disposed in the slot having slot identification number 77 shifted from the slot having slot identification number 74 by a coil pitch of 3. The coil W5-1 is disposed in slots shifted from those of the coil U5-1 by a slot pitch of 1. In other words, the coil W5-1 is disposed in the slots having slot identification numbers 75 and 78, upon being shaped so that currents flow in opposite directions through the winding disposed in the slot having slot identification number 75 and the winding disposed in the slot having slot identification number 78 shifted from the slot having slot identification number 75 by a coil pitch of 3. The coil V5-2 is disposed in slots shifted from those of the coil V5-1 by a slot pitch of 6. In other words, the coil V5-2 is disposed in the slots having slot identification numbers 79 and 82, upon being shaped so that currents flow in opposite directions through the winding disposed in the slot having slot identification number 79 and the winding disposed in the slot having slot identification number 82 shifted from the slot having slot identification number 79 by a coil pitch of 3. The coil U5-2 is disposed in slots shifted from those of the coil V5-2 by a slot pitch of 1. In other words, the coil U5-2 is disposed in the slots having slot identification numbers 80 and 83, upon being shaped so that currents flow in opposite directions through the winding disposed in the slot having slot identification number 80 and the winding disposed in the slot having slot identification number 83 shifted from the slot having slot identification number 80 by a coil pitch of 3. The coil W5-2 is disposed in slots shifted from those of the coil U5-2 by a slot pitch of 1. In other words, the coil W5-2 is disposed in the slots having slot identification numbers 81 and 84, upon being shaped so that currents flow in opposite directions through the winding disposed in the slot having slot identification number 81 and the winding disposed in the slot having slot identification number 84 shifted from the slot having slot identification number 81 by a coil pitch of 3. The coil V5-3 is disposed in slots shifted from those of the coil V5-2 by a slot pitch of 6. In other words, the coil V5-3 is disposed in the slots having slot identification numbers 85 and 88, upon being shaped so that currents flow in opposite directions through the winding disposed in the slot having slot identification number 85 and the winding disposed in the slot having slot identification number 88 shifted from the slot having slot identification number 85 by a coil pitch of 3. The coil U5-3 is disposed in slots shifted from those of the coil V5-3 by a slot pitch of 1. In other words, the coil U5-3 is disposed in the slots having slot identification numbers 86 and 89, upon being shaped so that currents flow in opposite directions through the winding disposed in the slot having slot identification number 86 and the winding disposed in the slot having slot identification number 89 shifted from the slot having slot identification number 86 by a coil pitch of 3. The coil W5-3 is disposed in slots shifted from those of the coil U5-3 by a slot pitch of 1. In other words, the coil W5-3 is disposed in the slots having slot identification numbers 87 and 90, upon being shaped so that currents flow in opposite directions through the winding disposed in the slot having slot identification number 87 and the winding disposed in the slot having slot identification number 90 shifted from the slot having slot identification number 87 by a coil pitch of 3.

In the sixth group of coils, one lap winding set in which three coils W6-1, V6-1, and U6-1 having the same coil pitch are arranged in slots shifted from each other by a slot pitch of 1 is formed, another lap winding set in which three coils W6-2, V6-2, and U6-2 having the same coil pitch are arranged in slots shifted from each other by a slot pitch of 1 is formed to be shifted from the first lap winding set by six slots in the circumferential direction, and still another lap winding set in which three coils W6-3, V6-3, and U6-3 having the same coil pitch are arranged in slots shifted from each other by a slot pitch of 1 is formed to be shifted from the second lap winding set by six slots in the circumferential direction. The sixth group of coils is shifted in position from the fifth group of coils by 60 degrees in the circumferential direction (in the example illustrated in FIG. 20, clockwise). More specifically, the coil W6-1 is disposed in the slots having slot identification numbers 91 and 94, upon being shaped so that currents flow in opposite directions through the winding disposed in the slot having slot identification number 91 and the winding disposed in the slot having slot identification number 94 shifted from the slot having slot identification number 91 by a coil pitch of 3. The coil V6-1 is disposed in slots shifted from those of the coil W6-1 by a slot pitch of 1. In other words, the coil V6-1 is disposed in the slots having slot identification numbers 92 and 95, upon being shaped so that currents flow in opposite directions through the winding disposed in the slot having slot identification number 92 and the winding disposed in the slot having slot identification number 95 shifted from the slot having slot identification number 92 by a coil pitch of 3. The coil U6-1 is disposed in slots shifted from those of the coil V6-1 by a slot pitch of 1. In other words, the coil U6-1 is disposed in the slots having slot identification numbers 93 and 96, upon being shaped so that currents flow in opposite directions through the winding disposed in the slot having slot identification number 93 and the winding disposed in the slot having slot identification number 96 shifted from the slot having slot identification number 93 by a coil pitch of 3. The coil W6-2 is disposed in slots shifted from those of the coil W6-1 by a slot pitch of 6. In other words, the coil W6-2 is disposed in the slots having slot identification numbers 97 and 100, upon being shaped so that currents flow in opposite directions through the winding disposed in the slot having slot identification number 97 and the winding disposed in the slot having slot identification number 100 shifted from the slot having slot identification number 97 by a coil pitch of 3. The coil V6-2 is disposed in slots shifted from those of the coil W6-2 by a slot pitch of 1. In other words, the coil V6-2 is disposed in the slots having slot identification numbers 98 and 101, upon being shaped so that currents flow in opposite directions through the winding disposed in the slot having slot identification number 98 and the winding disposed in the slot having slot identification number 101 shifted from the slot having slot identification number 98 by a coil pitch of 3. The coil U6-2 is disposed in slots shifted from those of the coil V6-2 by a slot pitch of 1. In other words, the coil U6-2 is disposed in the slots having slot identification numbers 99 and 102, upon being shaped so that currents flow in opposite directions through the winding disposed in the slot having slot identification number 99 and the winding disposed in the slot having slot identification number 102 shifted from the slot having slot identification number 99 by a coil pitch of 3. The coil W6-3 is disposed in slots shifted from those of the coil W6-2 by a slot pitch of 6. In other words, the coil W6-3 is disposed in the slots having slot identification numbers 103 and 106, upon being shaped so that currents flow in opposite directions through the winding disposed in the slot having slot identification number 103 and the winding disposed in the slot having slot identification number 106 shifted from the slot having slot identification number 103 by a coil pitch of 3. The coil V6-3 is disposed in slots shifted from those of the coil W6-3 by a slot pitch of 1. In other words, the coil V6-3 is disposed in the slots having slot identification numbers 104 and 107, upon being shaped so that currents flow in opposite directions through the winding disposed in the slot having slot identification number 104 and the winding disposed in the slot having slot identification number 107 shifted from the slot having slot identification number 104 by a coil pitch of 3. The coil U6-3 is disposed in slots shifted from those of the coil V6-3 by a slot pitch of 1. In other words, the coil U6-3 is disposed in the slots having slot identification numbers 105 and 108, upon being shaped so that currents flow in opposite directions through the winding disposed in the slot having slot identification number 105 and the winding disposed in the slot having slot identification number 108 shifted from the slot having slot identification number 105 by a coil pitch of 3.

The above-mentioned coils U1-1, U1-2, U1-3, U2-1, U2-2, U2-3, U3-1, U3-2, U3-3, U4-1, U4-2, U4-3, U5-1, U5-2, U5-3, U6-1, U6-2, and U6-3 are connected to each other via a crossover line and serve as U-phase windings in the stator 1. The above-mentioned coils V1-1, V1-2, V1-3, V2-1, V2-2, V2-3, V3-1, V3-2, V3-3, V4-1, V4-2, V4-3, V5-1, V5-2, V5-3, V6-1, V6-2, and V6-3 are connected to each other via a crossover line and serve as V-phase windings in the stator 1. The above-mentioned coils W1-1, W1-2, W1-3, W2-1, W2-2, W2-3, W3-1, W3-2, W3-3, W4-1, W4-2, W4-3, W5-1, W5-2, W5-3, W6-1, W6-2, and W6-3 are connected to each other via a crossover line and serve as W-phase windings in the stator 1. The 34-pole, 108-slot three-phase AC motor includes the above-mentioned stator 1, and a rotor facing the stator 1 in the radial direction.

In the 34-pole, 108-slot three-phase AC motor, the axes of line symmetry 100U, 100V, and 100W of the respective phases coincide with lines dividing the first to sixth groups of coils.

The three-phase AC motors having 10 poles and 36 slots, 10 poles and 24 slots, 14 poles and 24 slots, 22 poles and 48 slots, 22 poles and 72 slots, and 34 poles and 108 slots have been taken as examples above, but the present invention is not limited to these examples, and is also applicable to three-phase AC motors having poles and slots in numbers other than the above-mentioned numbers, in which letting 6N be the number of slots, and 2P be the number of poles, the value obtained by dividing the number of slots 6N by the number of poles 2P takes no integer. In each drawing, the order of assignment of slot identification numbers is merely an example.

In this manner, with the stator of the three-phase AC motor according to the embodiment of the present disclosure, since discontinuous lap winding is formed instead of full circle winding, the number of coils involved in the stator configuration is kept smaller. Since a fractional-slot three-phase AC motor in which the value obtained by dividing the number of slots by the number of poles takes an irreducible fraction is formed, the coil pitch (=Quotient, That Is, Decimal Integer Part of Value Obtained by (Number of Slots)/(Number of Poles), or (Quotient, That Is, Decimal Integer Part of Value Obtained by (Number of Slots)/(Number of Poles))+1) is small, and the coil ends are thus formed short. Since portions where the coil ends do not overlap each other are present, no operation for interchanging coils, as in the conventional methods, is involved, and a winding operation can thus easily be automated.

The stator of the three-phase AC motor according to the embodiment of the present disclosure allows winding that uses an inserter automatic winding machine. The inserter scheme is performed by the following procedure: First, coils (multiple coils) are fabricated by simultaneously winding them around several concentric winding frames using a nozzle, and inserted into an inserter. The inserter is then inserted into a stator to push the coils into the stator. In practice, a guide jig for pushing the coils into the inserter may be disposed.

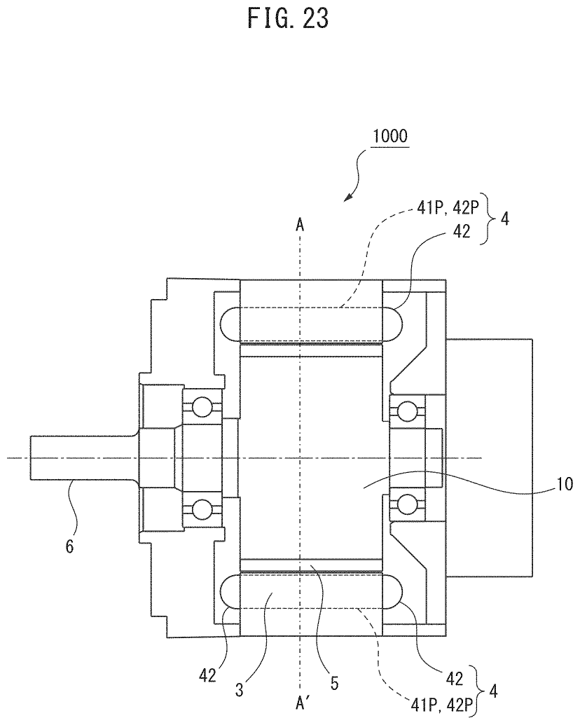

FIG. 23 is a diagram illustrating an exemplary appearance of a three-phase AC motor including the stator according to any embodiment of the present disclosure.

A three-phase AC motor 1000 according to an embodiment of the present disclosure includes the above-mentioned stator 1, and a rotor 10 facing the stator 1 in the radial direction. Referring to FIG. 23, reference numeral 3 denotes a stator core; and 4, coils. Each coil 4 is formed by a positive winding (+winding) 41P and a negative winding (−winding) 41N accommodated in slots, and coil ends 42 that are not accommodated in the slots. Reference numeral 5 denotes a magnet provided on the rotor 10; and 6, a rotating shaft of the rotor 10.

### REFERENCE SIGNS LIST

1 Stator

2 Slot

3 Stator core

4 Coil (winding)

5 Magnet

6 Rotating shaft

10 Rotor

21 Magnetic pole

41P +(Positive) winding

41N −(Negative) winding

42 Coil end

61 −U-phase belt axis of line symmetry, and vector pointing in arrangement direction

62 +V-phase belt axis of line symmetry, and vector pointing in arrangement direction

63 −W-phase belt axis of line symmetry, and vector pointing in arrangement direction

64 +U-phase belt axis of line symmetry, and vector pointing in arrangement direction

65 −V-phase belt axis of line symmetry, and vector pointing in arrangement direction

66 +W-phase belt axis of line symmetry, and vector pointing in arrangement direction

100 Lines dividing lap winding sets, disposed in all slots of stator, every 60 degrees in circumferential direction

100U Line dividing all slots of stator into two parts, and axis of line symmetry of U-phase windings

100V Line dividing all slots of stator into two parts, and axis of line symmetry of V-phase windings

100W Line dividing all slots of stator into two parts, and axis of line symmetry of W-phase windings

1000 Three-phase AC motor

1. A stator for a fractional-slot three-phase alternating-current motor in which the number of slots of slots arranged in a circumferential direction is larger than 1.5 times the number of poles, and a value obtained by dividing the number of slots by the number of poles takes an irreducible fraction, the stator comprising:
a plurality of sets of coils each formed by one of a set of two coils and a set of three coils having an equal coil pitch and arranged in the slots to be shifted from each other by a slot pitch of 1,
wherein the plurality of sets of coils are shifted in position from each other by 60 degrees in a circumferential direction.

2. The stator according to claim 1, wherein
the plurality of sets of coils are formed by a first group of coils to a sixth group of coils,
the second group of coils is shifted in position from the first group of coils by 60 degrees in a circumferential direction,
the third group of coils is shifted in position from the second group of coils by 60 degrees in a direction identical to the circumferential direction,
the fourth group of coils is shifted in position from the third group of coils by 60 degrees in a direction identical to the circumferential direction,
the fifth group of coils is shifted in position from the fourth group of coils by 60 degrees in a direction identical to the circumferential direction, and
the sixth group of coils is shifted in position from the fifth group of coils by 60 degrees in a direction identical to the circumferential direction.

3. The stator according to claim 2, wherein
each of the plurality of sets of coils comprises the set of three coils, and
the three coils respectively serve as a first-phase winding, a second-phase winding, and a third-phase winding of a three-phase alternating-current winding.

4. The stator according to claim 2, wherein
each of the plurality of sets of coils comprises the set of two coils, and
the two coils respectively serve as windings of two phases among a first-phase winding, a second-phase winding, and a third-phase winding of a three-phase alternating-current winding.

5. The stator according to claim 3, wherein the first-phase windings in the first group of coils to the sixth group of coils are arranged in line symmetry with respect to a first axis of line symmetry, the second-phase windings in the first group of coils to the sixth group of coils are arranged in line symmetry with respect to a second axis of line symmetry, and the third-phase windings in the first group of coils to the sixth group of coils are arranged in line symmetry with respect to a third axis of line symmetry.

6. The stator according to claim 1, wherein the number of pole pairs on the three-phase alternating-current motor comprises an odd number of not less than 5.

7. The stator according to claim 3, wherein the value obtained by dividing the number of slots by the number of poles in the three-phase alternating-current motor is larger than 3 and less than 4.

8. The stator according to claim 4, wherein the value obtained by dividing the number of slots by the number of poles in the three-phase alternating-current motor is larger than 1.5 and less than 3.

9. A three-phase alternating-current motor comprising:
the stator according to claim 1; and
a rotor facing the stator in a radial direction.

10. The stator according to claim 4, wherein the first-phase windings in the first group of coils to the sixth group of coils are arranged in line symmetry with respect to a first axis of line symmetry, the second-phase windings in the first group of coils to the sixth group of coils are arranged in line symmetry with respect to a second axis of line symmetry, and the third-phase windings in the first group of coils to the sixth group of coils are arranged in line symmetry with respect to a third axis of line symmetry.
